(19) United States
(12) Patent Application Publication
(10) Pub. No.: US 2024/0257547 A1
(43) Pub. Date: Aug. 1, 2024

(54) INFORMATION PROCESSING SYSTEM, METHOD, AND NON-TRANSITORY COMPUTER-EXECUTABLE MEDIUM

(71) Applicant: PFU LIMITED, Ishikawa (JP)

(72) Inventors: Katsuhiro HATTORI, Ishikawa (JP); Akira TAKANO, Ishikawa (JP)

(21) Appl. No.: 18/424,291

(22) Filed: Jan. 26, 2024

(30) Foreign Application Priority Data
Jan. 30, 2023 (JP) 2023-011609

(51) Int. Cl. G06V 30/19; G06V 30/12; G06V 30/148; G06V 30/162; G06V 30/164; G06V 30/18; G06V 30/40

(52) U.S. Cl. CPC G06V 30/19113; G06V 30/133; G06V 30/155; G06V 30/162; G06V 30/164; G06V 30/1801; G06V 30/18105; G06V 30/40

(57) ABSTRACT

An information processing system includes circuitry. The circuitry acquires a captured image by capturing a document. The circuitry performs an analysis process using the captured image. The circuitry selects, for each of at least one setting item of a plurality of setting items relating to image processing to be performed on the captured image, at least one setting value from among configurable setting values as a candidate for a recommended setting. The circuitry performs image processing repeatedly on the captured image while changing setting values of the plurality of setting items with a setting value of the at least one setting item restricted to the at least one setting value selected as the candidate for the recommended setting. The circuitry determines recommended settings for the plurality of setting items relating to image processing to obtain an image suitable for character recognition.

### CROSS-REFERENCE TO RELATED APPLICATION

This patent application is based on and claims priority pursuant to 35 U.S.C. § 119(a) to Japanese Patent Application No. 2023-011609, filed on Jan. 30, 2023, in the Japan Patent Office, the entire disclosure of which is hereby incorporated by reference herein.

### BACKGROUND

### Technical Field

Embodiments of the present disclosure relate to an information processing system, a method, and a non-transitory computer-executable medium.

### Related Art

A method for optimizing a character recognition parameter is known in the art. The method includes a first means for holding image information relating to a character in the same form, the image information being acquired by only one scan of the same form such that the image information can be read multiple times. The method includes a second means for repeating character recognition processing a predetermined number of times, the character recognition processing being performed by reading image information relating to a character in a form and an automatically set parameter relating to character recognition accuracy. The method includes a third means for outputting the image information every time the second means repeats the character recognition processing as if the image information is acquired by actually scanning the same form. The method includes a fourth means for, each time a result of the character recognition processing is output from the second means, measuring accuracy of character recognition on the basis of the result and correct answer information about the character in the form.

### SUMMARY

According to an embodiment of the present disclosure, an information processing system includes circuitry. The circuitry acquires a captured image by capturing a document. The circuitry performs an analysis process using the captured image. Based on a result of the analysis process, the circuitry selects, for each of at least one setting item of a plurality of setting items relating to image processing to be performed on the captured image, at least one setting value from among configurable setting values as a candidate for a recommended setting. The circuitry performs image processing repeatedly on the captured image while changing setting values of the plurality of setting items with a setting value of the at least one setting item restricted to the at least one setting value selected as the candidate for the recommended setting. Based on a result of the image processing, the circuitry determines recommended settings for the plurality of setting items relating to image processing to obtain an image suitable for character recognition.

According to an embodiment of the present disclosure, an information processing system includes circuitry. The circuitry acquires a plurality of captured images by capturing a plurality of documents. The circuitry performs an analysis process using any of the plurality of captured images. Based on a result of the analysis process, the circuitry selects, for each of at least one setting item of a plurality of setting items relating to image processing to be performed on the plurality of captured images, at least one setting value from among configurable setting values as a candidate for a recommended setting. The circuitry performs image processing repeatedly on any of the plurality of the captured images while changing setting values of the plurality of setting items with a setting value of the at least one setting item restricted to the at least one setting value selected as the candidate for the recommended setting. Based on a result of the image processing, the circuitry determines recommended settings for the plurality of setting items relating to image processing to obtain an image suitable for character recognition.

According to an embodiment of the present disclosure, a method includes acquiring a captured image by capturing a document. The method includes performing an analysis process using the captured image. The method includes, based on a result of the analysis process, selecting, for each of at least one setting item of a plurality of setting items relating to image processing to be performed on the captured image, at least one setting value from among configurable setting values as a candidate for a recommended setting. The method includes performing image processing repeatedly on the captured image while changing setting values of the plurality of setting items with a setting value of the at least one setting item restricted to the at least one setting value selected as the candidate for the recommended setting. The method includes, based on a result of the image processing, determining recommended settings for the plurality of setting items relating to image processing to obtain an image suitable for character recognition.

According to an embodiment of the present disclosure, a non-transitory computer-executable medium stores a plurality of instructions which, when executed by a processor, causes the processor to perform a method. The method includes acquiring a captured image by capturing a document. The method includes performing an analysis process using the captured image. The method includes, based on a result of the analysis process, selecting, for each of at least one setting item of a plurality of setting items relating to image processing to be performed on the captured image, at least one setting value from among configurable setting values as a candidate for a recommended setting. The method includes performing image processing repeatedly on the captured image while changing setting values of the plurality of setting items with a setting value of the at least one setting item restricted to the at least one setting value selected as the candidate for the recommended setting. The method includes, based on a result of the image processing, determining recommended settings for the plurality of setting items relating to image processing to obtain an image suitable for character recognition.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of a system, according to Embodiment 1 of the present disclosure;

FIG. 2 is a schematic diagram illustrating a functional configuration of an information processing apparatus, according to Embodiment 1 of the present disclosure;

FIG. 3 is a table of image processing setting items relating to optical character recognition (OCR) and options for individual setting items, according to an embodiment of the present disclosure;

FIG. 4 is a diagram illustrating a captured image converted to a gray scale, according to an embodiment of the present disclosure;

FIG. 5 is a diagram illustrating the histogram of an edge image, according to an embodiment of the present disclosure;

FIG. 6 is a diagram illustrating line segments extracted from a captured image, according to an embodiment of the present disclosure;

FIG. 7 is a diagram illustrating a binarized image (an image obtained by extracting an OCR area) of a captured image, according to an embodiment of the present disclosure;

FIG. 8 is a table of setting values according to the estimated amount of noise, according to an embodiment of the present disclosure;

FIG. 9 is a table of multiple setting items associated with options obtained by a process of narrowing down, according to an embodiment of the present disclosure;

FIG. 10 is a table for describing a method of evaluating a character recognition result, according to an embodiment of the present disclosure;

FIG. 11A and FIG. 11B are tables for describing a method of calculating an evaluation value on the basis of a confidence level, according to an embodiment of the present disclosure;

FIG. 12 is a diagram illustrating a pre-setting window, according to an embodiment of the present disclosure;

FIG. 13 is a diagram illustrating a recommended setting determination window, according to an embodiment of the present disclosure;

FIG. 14 is a diagram illustrating a progress display window, according to an embodiment of the present disclosure;

FIG. 15 is a diagram illustrating a recommended setting saving window, according to an embodiment of the present disclosure;

FIG. 16 is a flowchart of a process for determining a recommended setting, according to Embodiment 1;

FIG. 17 is a schematic diagram illustrating a configuration of a system, according to Embodiment 2;

FIG. 18 is a schematic diagram illustrating a functional configuration of a server, according to Embodiment 2;

FIG. 19 is a schematic diagram illustrating a configuration of a system, according to Embodiment 3;

FIG. 20 is a schematic diagram illustrating a functional configuration of a scanner, according to Embodiment 3;

FIG. 21 is a schematic diagram illustrating a functional configuration of an information processing apparatus, according to Embodiment 4;

FIG. 22 is a diagram illustrating a document scan window, according to an embodiment of the present disclosure;

FIG. 23 is a diagram illustrating a pre-setting window before any setting is not yet configured, according to an embodiment of the present disclosure;

FIG. 24 is a diagram illustrating a pre-setting window after the configuration of settings is completed, according to an embodiment of the present disclosure;

FIG. 25 is a diagram illustrating an evaluation result displaying window, according to an embodiment of the present disclosure;

FIG. 26 is a diagram illustrating the evaluation result displaying window that is displayed when correct text is obtained, according to an embodiment of the present disclosure;

FIG. 27 is a diagram illustrating the evaluation result displaying window that is displayed when correct text is not obtained, according to an embodiment of the present disclosure;

FIG. 28 is a flowchart of a process for displaying an evaluation result, according Embodiment 4;

FIG. 29 is a flowchart of a pop-up display process, according to Embodiment 4; and

FIG. 30 is a schematic diagram illustrating a functional configuration of an information processing apparatus, according to Embodiment 5.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system, an information processing apparatus, a method, and a program according to embodiments of the present disclosure are described below with reference to the drawings. Embodiments described below are illustrative, and do not limit the information processing system, the information processing apparatus, the method, and the program according to the present disclosure to the specific configurations described below. In the implementation, specific configurations may be adopted appropriately according to the mode of implementation, and various improvements and modifications may be made.

The present disclosure can be understood as an information processing apparatus, a system, a method executed by a computer, or a program executed by a computer. Further, the present disclosure can also be understood as a storage medium that stores such a program and that can be read by, for example, a computer or any other apparatus or machine. The storage medium that can be read by, for example, the computer refers to a storage medium that can store information such as data or programs by electrical, magnetic, optical, mechanical, or chemical action, and that can be read by, for example, a computer.

### Embodiment 1

In Embodiment 1 to Embodiment 3, a description is given of embodiments of a case where an information processing system, an information processing apparatus, a method, and a program according to the present disclosure are implemented in a system that estimates (determines) image processing settings for a scanner to make an image obtained by reading a document by the scanner suitable for character recognition such as optical character recognition (OCR). However, the information processing system, the information processing apparatus, the method, and the program according to the present disclosure can be widely used for a technology for estimating image processing settings for obtaining an image suitable for character recognition, and what the present disclosure is applied is not limited to those described below in the embodiments.

In the related art, automatic binarization (binarization image processing technique) is known as a technique for outputting an optimized image for OCR. Such a technique is a technique (function) of automatically determining a binarization parameter (parameter value) for outputting an appropriate binary black and white image corresponding to a document (document to be read) by analyzing some features of the document during scanning.

However, this feature analysis alone may not provide sufficient recognition accuracy when OCR processing is performed on an output image. For example, according to this technique, a background portion and a text portion are not distinguished (i.e., the determination is made using a grayed histogram). Accordingly, when a document includes a particularly complicated background pattern or watermark, the background portion may remain in the output image or a part of the text portion may disappear. In such a case, the recognition accuracy of OCR is not sufficient. Further, according to this technique, since the binarization parameter is determined by analyzing the document during scanning, a processing time is an issue when high-speed and large-volume scanning is to be performed. For this reason, instead of determining the parameter during scanning, a method of generating a more accurate profile (i.e., a profile achieving more accurate recognition) in advance according to the document is an issue.

To address such an issue, one possible way is to perform image processing and OCR processing for all combinations of multiple image processing (image processing settings) relating to OCR, and select a particular combination achieving the highest OCR recognition accuracy from among all the combinations as image processing settings suitable for OCR. However, there are many settings relating to OCR (which affect OCR accuracy). Accordingly, just combining (multiplying) multiple image processing relating to OCR generates a huge number of combinations. It is not realistic to perform the above-described processing for all of the combinations. In view of this, reducing the number of combinations may be one option. However, when the combinations are randomly thinned out, settings suitable for OCR may not be obtained. For example, even a small amount of noise remaining in an output image affects the recognition accuracy of OCR, and thus it is preferable to perform fine adjustment of parameter values (image processing settings) to minimize the amount of noise remaining. However, when a setting suitable for OCR is thinned out by randomly thinning out the combinations, it is difficult to perform the fine adjustment.

In view of the above, the information processing system, the information processing apparatus, the method, and the program according to embodiments of the present disclosure select a candidate (a setting value) of a recommended setting by performing an analysis process using a captured image. The information processing system, the information processing apparatus, the method, and the program according to embodiments determine recommended settings for multiple setting items by repeatedly trying image processing on the captured image with setting values of the multiple setting items being changed from one to another, while limiting to the setting value selected as the candidate for the recommended setting (i.e., an image processing setting that makes an obtained image suitable for character recognition). Thus, an image processing setting with which an image suitable for character recognition processing can be obtained is determined in a simple manner. With this configuration, an image processing setting configuration achieving higher accuracy (higher recognition accuracy) is determined in advance according to a document. In other words, a profile achieving higher accuracy (higher recognition accuracy) is generated in advance.

### System Configuration

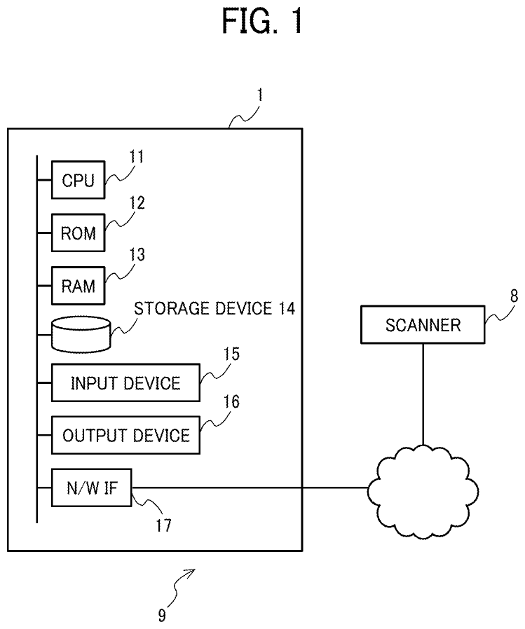

FIG. 1 is a schematic diagram illustrating a configuration of a system 9 according to the present embodiment. The system 9 according to the present embodiment includes a scanner 8 and an information processing apparatus 1 that are communicably connected to each other via a network or other communication means.

The information processing apparatus 1 is a computer including a central processing unit (CPU) 11, a read-only memory (ROM) 12, a random-access memory (RAM) 13, a storage device 14 such as an electrically erasable programmable read-only memory (EEPROM) and a hard disk drive (HDD), an input device 15 such as a keyboard, a mouse, and a touch panel, an output device 16 such as a display, and a communication unit 17 such as a network interface card (NIC). Regarding the specific hardware configuration of the information processing apparatus 1, any component may be omitted, replaced, or added as appropriate according to a mode of implementation. Further, the information processing apparatus 1 is not limited to an apparatus having a single housing. The information processing apparatus 1 may be implemented by multiple apparatuses using, for example, a so-called cloud or distributed computing technology.

The scanner 8 is an apparatus (an image reading apparatus) that captures an image of a document placed on the scanner 8 by a user to obtain an image (image data). Examples of the document include a text document, a business card, a receipt, a photograph, and an illustration. In the description, a scanner is used to exemplify the image reading apparatus according to the present embodiment. However, the image reading apparatus is not limited to a scanner. For example, a multifunction peripheral may be used as the image reading apparatus. The scanner 8 according to the present embodiment has a function of transmitting image data obtained by image capturing to the information processing apparatus 1 through a network.

The scanner 8 may further include a user interface, such as a touch panel display and a keyboard, for inputting and outputting characters and selecting a desired item. The scanner 8 may further have a web browsing function and a server function. The communication means, the hardware configuration, and other configurations of the scanner that adopts the method according to the present embodiment are not limited to the illustrative examples described in the present embodiment.

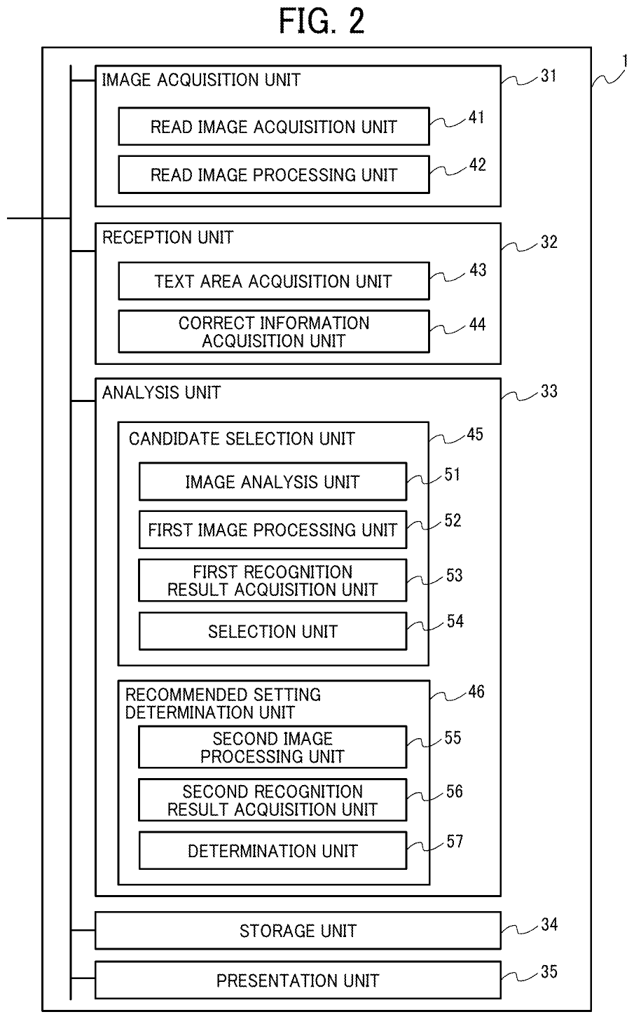

FIG. 2 is a schematic diagram illustrating a functional configuration of the information processing apparatus 1 according to the present embodiment. The CPU 11 executes a program loaded onto the RAM 13 from the storage device 14, to control the hardware components of the information processing apparatus 1. Thus, the information processing apparatus 1 functions as an apparatus including an image acquisition unit 31, a reception unit 32, an analysis unit 33, a storage unit 34, and a presentation unit 35. The image acquisition unit 31 includes a read image acquisition unit 41 and a read image processing unit 42. The reception unit 32 includes a text area acquisition unit 43 and a correct information acquisition unit 44. The analysis unit 33 includes a candidate selection unit 45 and a recommended setting determination unit 46. In the present embodiment and other embodiments described below, the functions of the information processing apparatus 1 are executed by the CPU 11 which is a general-purpose processor. Alternatively, a part or all of these functions may be executed by one or multiple dedicated processors.

The image acquisition unit 31 acquires a captured image (document image) obtained by imaging a document. In the present embodiment, the image acquisition unit 31 corresponds to a driver (scanner driver) of the scanner 8 (“reading unit” in the present embodiment), and controls the scanner 8 to capture an image of a placed document by the scanner 8, and acquires the captured image of the document, accordingly. Specifically, the image acquisition unit 31 includes a read image acquisition unit 41 and a read image processing unit 42 (“image processing means” in the present embodiment), the read image acquisition unit 41 acquires a read image generated by reading a document by the scanner 8, and the read image processing unit 42 acquires an image (processed image) on which image processing has been performed by performing image processing on the read image. In the present embodiment, the read image refers to an image (raw image) that has not been subjected to image processing.

A document to be read or scanned by the scanner 8 (a document to be used for an analysis process described below, and referred to as a “read document” in the following description) may be any document, for example, a document being used when the scanner 8 is operated (e.g., a customer operation document). The scanned document may be either a single page or multiple pages. When the scanner 8 reads (performs image capturing of) multiple pages of a document, the read image acquisition unit 41 acquires a captured image for each of the multiple pages of the document. The image processing performed on the processed image may be any image processing. Further, when the scanner 8 includes an image processing unit (the read image processing unit 42), the image acquisition unit 31 acquires the processed image in addition to the read image from the scanner 8.

The reception unit 32 receives designation of an OCR area and input of a correct character string for the read document by receiving an operation by the user for selecting a field (a text area (OCR area) which is an area including a character string desired to be subjected to character recognition by the user) in the read document (captured image) and an operation by the user for inputting the correct character string written in the area. In other words, in response to an operation of specifying an OCR area performed by the user and an operation of inputting a correct character string performed by the user (correct text read from the OCR area by the user), the text area acquisition unit 43 acquires the OCR area, and the correct information acquisition unit 44 acquires the correct character string (correct information) for the OCR area. The number of OCR areas to be selected may be one or multiple.

The analysis unit 33 determines (estimates) an image processing setting (recommended setting suitable for the read document) recommended for obtaining an image (binarized image) suitable for character recognition, based on the captured image (read image or processed image). Specifically, the analysis unit 33 determines, using the captured image, a recommended setting (recommended values) for multiple setting items in image processing to be performed by the image processing unit (the read image processing unit 42) to obtain an image suitable to be subjected to character recognition, the image processing being to be performed on a read image obtained by reading the read document read by the scanner 8. The setting items for which the recommended setting is to be determined are image processing setting items relating to character recognition (OCR). More specifically, the setting items for which the recommended setting is to be determined are image processing setting items which may affect character recognition (i.e., a character recognition result). In other words, the setting items for which the recommended setting is to be determined are setting items for which the character recognition result of an image obtained as a result of image processing may differ according to setting contents. In the present embodiment, examples of the setting items for which the recommended setting is to be determined include an image processing setting item relating to a character thickness, background pattern removal, character extraction for specific characters (special characters), a dropout color, binarization sensitivity, and noise removal. However, the setting items for which the recommended setting is to be determined are not limited to the above-described illustrative items. The setting items for which the recommended setting may be any setting item and any number of setting items.

Further, the setting items for which the recommended setting is to be determined may include a setting item other than the image processing setting items relating to character recognition.

The image processing setting items include a setting item that greatly affects the entire document (i.e., the entire captured image of the document). For such a setting item, the characteristics of the document can be roughly obtained (recognized) by, for example, performing document analysis (captured image analysis) or by trying image processing multiple times with a setting value being changed from one to another. Thus, multiple configurable setting values can be narrowed down to one or more setting values as candidates for the recommended setting (setting value candidates that can be the recommended setting (suitable as the recommended setting)).

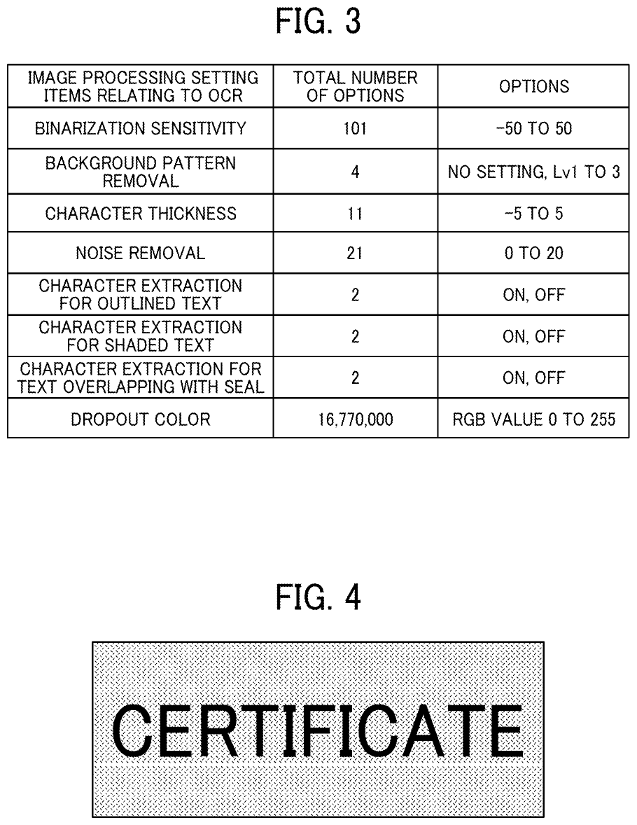

FIG. 3 is a table of image processing setting items relating to OCR and options for individual setting items, according to the present embodiment. In FIG. 3, setting items relating to OCR (image processing settings), and multiple configurable setting values (options) and the number of configurable setting values (total number of options) for each setting item, are illustrated. As illustrated in FIG. 3, because there are multiple configurable setting values (options) for each of the setting items relating to the OCR, the number of combinations of the options of the multiple setting items by simple multiplication is enormous. If verification (a process for determining a recommended setting configuration, which is described below) is performed for all of the combinations, an enormous amount of time is taken. In other words, there is not enough time to complete the verification. For this reason, in the present embodiment, an analysis process using the captured image is performed to narrow down the multiple configurable setting values to one or more setting value (to narrow down to one or more setting values as candidates for a recommended setting). In other words, by performing the analysis process using the captured image (analysis process that can capture the feature of the read document), the setting value corresponding to the result of the analysis process (the setting value corresponding to the feature of the read document) is determined as the candidate for the recommended setting. With this configuration, the number of combinations to be verified is reduced. Accordingly, in a recommended setting determination process described below, the verification (i.e., image processing and acquisition of a character recognition result) does not have to be performed for all of the combinations obtained by simply multiplying the options illustrated in FIG. 3. In other words, the number of times (the number of repetitions) of performing the image processing and the acquisition of a character recognition result can be reduced, and a recommended setting is determined in a short time.

As described above, in the present embodiment, the analysis unit 33 selects a candidate (candidate value) for a recommended setting by performing the analysis process using the captured image, and determines a recommended setting using the selected candidate for the recommended setting. A description is now given of the candidate selection unit 45 that selects a candidate for a recommended setting and the recommended setting determination unit 46 that determines a recommended setting.

### Candidate Selection

The candidate selection unit 45 performs an analysis process using a captured image to select a setting value, which is a candidate for a recommended setting, from multiple configurable setting values, for each of at least one setting item among multiple setting items for which a recommended setting is to be determined. The number of setting values selected as a candidate for the recommended setting may be one or more. In the present embodiment, by performing the analysis process using the captured image, for example, the amount of background pattern, the presence of specific characters (e.g., outlined characters, shaded characters, characters overlapping with a seal), the presence of ruled lines (the color of ruled lines), and the amount of noise (the presence of noise) are captured as features of a read document (captured image). In the present embodiment, as one example, candidates for recommended settings for image processing setting items relating to background pattern removal, specific character extraction, dropout color, binarization sensitivity, and noise removal are selected. It is assumed that, when selecting a candidate value for a certain setting item, the candidate selection unit 45 performs the analysis process that can capture a feature (feature of the read document) relating to the certain setting item.

The method of selecting the candidate (candidate value) for the recommended setting includes two methods, which is a Method 1 and a Method 2. According to the first method (the Method 1), a candidate value is selected by performing image analysis on a captured image.

According to the second method (the Method 2), image processing is tried on a captured image with a configurable setting value, and a candidate value is selected on the basis of a character recognition result for an image obtained as a result of the trial. In the following description, such a method may be referred to as “unit verification.” In the present embodiment, in order to select the candidates for recommended settings for multiple setting items by the Method 1 and/or the Method 2, the candidate selection unit 45 includes an image analysis unit 51, a first image processing unit 52, a first recognition result acquisition unit 53, and a selection unit 54. The image analysis unit 51 performs image analysis on the captured image according to the Method 1. The first image processing unit 52 performs (tries) image processing on the captured image according to the Method 2. The first recognition result acquisition unit 53 acquires an image obtained as a result of the trial (i.e., the captured image on which image processing has been performed) and a character recognition result (OCR result) for the captured image. The selection unit 54 selects a candidate value on the basis of the result of image analysis by the image analysis unit 51 or the character recognition result acquired by the first recognition result acquisition unit 53.

The first recognition result acquisition unit 53 may acquire the character recognition result by performing character recognition processing (OCR processing). Alternatively, the first recognition result acquisition unit 53 may acquire the character recognition result from another apparatus (apparatus including an OCR engine) that performs the character recognition process. A description is now given of a method of selecting a candidate for a recommended setting for each of the setting items.

### Background Pattern Removal

An image processing setting item relating to background pattern removal (in the following description, referred to as a “background pattern removal item”) is a setting item relating to image processing for removing a background pattern (including a watermark) included in a document (read image). When a document includes a background pattern, the character recognition accuracy for an image obtained by imaging the document sometimes deteriorates due to the influence of the background pattern. For this reason, in order to obtain an image suitable for character recognition, it is preferable to configure a setting for the background pattern removal item suitable for the document. A candidate for a recommended setting for the background pattern removal item can be selected by the Method 1 or the Method 2.

### Background Pattern Removal: Method 1

In the case of the Method 1, first, the image analysis unit 51 of the candidate selection unit 45 performs image analysis on a captured image to determine an amount of a background pattern. The selection unit 54 of the candidate selection unit 45 can estimate the amount of a background pattern included in the read document as a feature of the read document on the basis of the result of the image analysis. The selection unit 54 of the candidate selection unit 45 selects a setting value for the background pattern removal item according to the result of the image analysis (the estimation result of the feature of the document) as a candidate for the recommended setting. In the present embodiment, the candidate selection unit 45 performs edge analysis on the captured image (histogram analysis on an edge image), to determine (estimate) the amount of the background pattern of the read document. When a captured image is converted to a gray scale, the gradation value (pixel valuc) of a typical background pattern is lighter than a text portion (black), and the background pattern often looks like countless thin lines.

FIG. 4 is a diagram illustrating a (part of) captured image converted to a gray scale, according to the present embodiment. As illustrated in FIG. 4, in a captured image converted to a gray scale, a background pattern in the back of text is lighter than a text portion, and looks like countless thin lines. For this reason, in the present embodiment, edge analysis is performed on the captured image (image converted to a gray scale), and the amount of the background pattern included in the read document is estimated on the basis of the detected amount of edges. Specifically, the candidate selection unit 45 first extracts an edge portion (the amount of a change (the amount of edges) in a pixel value with respect to surrounding pixels) from the captured image converted into a gray scale by using an edge filter such as a Laplacian filter. In other words, the candidate selection unit 45 generates an edge image. Subsequently, the candidate selection unit 45 generates a histogram of the edge image (i.e., an edge amount histogram), and analyzes how one or more peaks appear in the generated histogram, to estimate the amount of the background pattern.

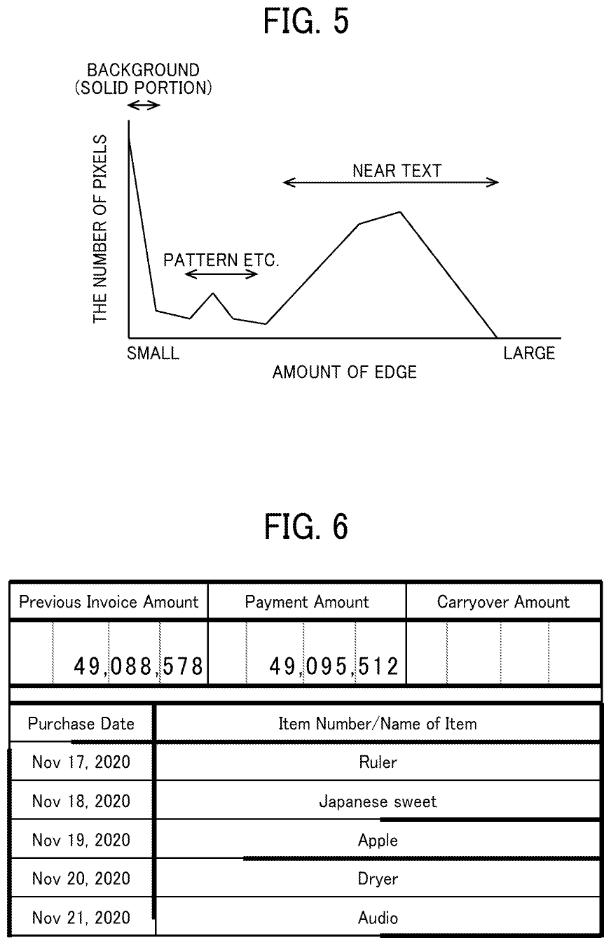

FIG. 5 is a diagram illustrating the histogram of the edge image, according to the present embodiment. In the histogram illustrated in FIG. 5, the horizontal axis represents the amount of edges (the gradation value (pixel value) in the edge image), and the vertical axis represents the number of pixels. In the histogram illustrated in FIG. 5, three peaks appear in ascending order of the gradation value. Since many edges are not detected in a background portion (solid portion) in the captured image, a peak in a part where the gradation value is low (a part where the amount of edges is small) is estimated as a peak corresponding to the background portion. Further, since many edges are detected in a text portion (near text) in the captured image, a peak in a part where the gradation value is high (a part where an amount of edges is large) is estimated as a peak corresponding to the text portion. Furthermore, as described above, since the background pattern is lighter than the text portion and looks like countless thin lines, the amount of edges detected in an area where the background pattern is present is estimated as being larger than the amount of edges detected in the background portion and smaller than the amount of edges detected in the text portion. Accordingly, as illustrated in FIG. 5, when a peak is present (at an intermediate position) between a peak corresponding to the background portion (solid portion) and a peak corresponding to the text portion in the edge amount histogram, the candidate selection unit 45 estimates (determines) that such a peak is a peak corresponding to a background pattern and that a background pattern is present in the read document. When the candidate selection unit 45 estimates that a background pattern is present, the candidate selection unit 45 estimates (guesses) the amount of background pattern included in the read document on the basis of the amount of the area corresponding to the background pattern (i.e., the number of pixels (frequency) near the peak corresponding to the background pattern).

Subsequently, the selection unit 54 of the candidate selection unit 45 selects a setting value corresponding to the image analysis result (i.e., the estimation result) from configurable setting values as a candidate for the recommended setting. For example, when the estimation result indicates that the document includes no background pattern, the candidate selection unit 45 selects, for example, “no background pattern removal (background pattern removal processing disabled)” as a candidate (candidate value) of the recommended setting for the background pattern removal item. When the estimation result indicates that the document includes a small amount of background pattern, the candidate selection unit 45 selects, for example, two setting values (i.e., “background pattern removal level 1 (Lv1)” and “background pattern removal level 2 (Lv2)”) in ascending order of the degree of background pattern removal as candidates (candidate values) of recommended settings for the background pattern removal item. When the estimation result indicates that the document includes a large amount of background pattern, the candidate selection unit 45 selects, for example, two setting values (i.e., “background pattern removal level 2 (Lv2)” and “background pattern removal level 3 (Lv3)”) in descending order of the degree of background pattern removal as candidates (candidate values) of recommended settings for the background pattern removal item.

Any method such as peak search may be used for detecting a peak in the histogram. Further, the above-described method is one example of image analysis for determining the amount of the background pattern. Any other methods (desired methods) may be used for the image analysis for determining the amount of the background pattern. Furthermore, the filter used for generating the edge image is not limited to the Laplacian filter, and any filter may be used.

### Background Pattern Removal: Method 2

In the case of the Method 2, the candidate selection unit 45 tries image processing on the captured image with configurable setting values (e.g., “no background pattern removal,” “background pattern removal level 1,” “background pattern removal level 2,” and “background pattern removal level 3”) for the background pattern removal item, to select a candidate for the recommended setting on the basis of character recognition results for the images obtained as the results of the trials. For example, when the captured image to be used is an image acquired with “no background pattern removal (i.e., a setting according to which no background pattern removal processing is performed),” the candidate selection unit tries image processing (i.e., background pattern removal processing) with three setting values “background pattern removal level 1,” “background pattern removal level 2,” and “background pattern removal level 3.” The candidate selection unit 45 selects a candidate value for the background pattern removal item on the basis of the character recognition results for three images obtained as a result of the trials and the captured image, which is an image corresponding to “no background pattern removal.” In other words, the candidate selection unit 45 compares the character recognition results for the images corresponding to the multiple setting values (i.e., the captured image for “no background pattern removal” and the images obtained as a result of the image processing with the multiple setting values for “background pattern removal level 1,” “background pattern removal level 2,” and “background pattern removal level 3”), to select the candidate value for the background pattern removal item. For example, when the result of comparison between the character recognition results indicates that the character recognition result for the image obtained by trying image processing with the setting value of “background pattern removal level 3” is the best, it is determined (estimated) that the read document includes a large amount of background patterns. In this case, the candidate selection unit 45 selects “background pattern removal level 2” and “background pattern removal level 3,” which are setting values with which background pattern removal is performed with a high degree, as candidates for the recommended setting.

In other words, the candidate selection unit 45 selects, from the configurable setting values, a predetermined number (one or more) of setting values (e.g., two setting values) selected in descending order of the character recognition results (recognition rates) for the images obtained as a result of trying image processing with the configurable setting values, as candidates for the recommended setting for the background pattern removal item. An evaluation method described below performed when determining a recommended setting may be used as a method for evaluating the character recognition results. In other words, the character recognition results may be compared with each other by Evaluation method 1 or Evaluation method 2 described below. Further, the one or more candidates may be selected by comparing the number of connected components (CCs) in addition to the character recognition result (OCR recognition rate). For example, a predetermined number (e.g., two) of favorable setting values are selected as candidate values in the order of the character recognition result and the number of CCs.

### Extraction of Specific Character

An image processing setting item relating to character extraction (function) (in the following description, referred to as a “character extraction item”) is a setting item relating to image processing for obtaining an image with high recognizability of characters even when a document includes a specific character which is difficult to recognize as it is. When a document includes a specific character such as an outlined character, a character with a shaded background, or a character overlapping with a seal, the character recognition accuracy of an image obtained by imaging the document sometimes deteriorates due to the influence of the specific character. For this reason, in order to obtain an image suitable for character recognition, it is preferable to configure a setting for the character extraction item suitable for the document. In the present embodiment, examples of the character extraction item include an image processing setting item relating to outlined character extraction, an image processing setting item relating to shaded character extraction, and an image processing setting item relating to seal overlapping character extraction. A candidate for a recommended setting for the character extraction item can be selected by the Method 2.

The candidate selection unit 45 performs image processing on the captured image with configurable setting values (e.g., “ON (enabled)” and “OFF (disabled)”) for the character extraction item, to select a candidate for the recommended setting on the basis of character recognition results for the image obtained as a result of the trials. For example, when the captured image to be used is an image acquired with “OFF (i.e., a setting according to which no character extraction processing is performed),” the candidate selection unit 45 tries image processing (character extraction processing) with the setting value “ON (enabled)” on the captured image. The candidate selection unit 45 selects a candidate value for the character extraction item on the basis of the character recognition results for an image (one image) obtained as a result of the trial and the captured image, which is an image corresponding to “OFF (disabled).” In other words, the candidate selection unit 45 compares the character recognition results for the images corresponding to the multiple setting values (i.e., the captured image for the setting value “OFF” and the image obtained as a result of the image processing with the setting value “ON” for the setting value “ON,” to select the candidate value for the character extraction item. For example, regarding the image processing setting item relating to the outlined character extraction, when the result of comparison between the character recognition result in the case of “ON” and the character recognition result in the case of “OFF” indicates that the character recognition result for the image obtained by trying the image processing with the setting value “ON” is better, it is determined (estimated) that the read document includes an outlined character. In this case, the candidate selection unit selects the setting value “ON,” which is a setting value with which outline character extraction is performed, as a candidate for the recommended setting.

In other words, the candidate selection unit 45 selects, from the configurable setting values (e.g., ON and OFF), a setting value (e.g., ON) with which the best character recognition result (character recognition rate) is obtained for the images obtained as a result of trying image processing with the configurable setting values, as a candidate for the recommended setting for the character extraction item. An evaluation method described below performed when determining a recommended setting may be used as a method for evaluating the character recognition results. In other words, the character recognition results may be compared with each other by the Evaluation method 1 or the Evaluation method 2 described below.

### Dropout Color

An image processing setting item relating to a dropout color (in the following description, referred to as a “dropout color item”) is a setting item for image processing for preventing a designated color from appearing in an image (or for making the designated color less likely to appear in an image). For example, when a document includes a ruled line, the character recognition accuracy for an image obtained by imaging the document sometimes deteriorates due to the influence of the ruled line. For this reason, in order to obtain an image suitable for character recognition, it is preferable to configure a setting for the dropout color item suitable for the document, such as setting the color of the ruled line as a dropout color and erasing the ruled line portion. A candidate for a recommended setting for the dropout color item can be selected by the Method 1.

First, the image analysis unit 51 of the candidate selection unit 45 performs image analysis on a captured image to determine the presence of a ruled line. The selection unit 54 of the candidate selection unit 45 can estimate the presence of a ruled line (whether a ruled line is present) in the read document as a feature of the read document on the basis of the result of the image analysis. The selection unit 54 of the candidate selection unit 45 selects a setting value for the dropout color item according to the result of the image analysis (the estimation result of the feature of the document) as a candidate for the recommended setting. In the present embodiment, the presence of a ruled line in the read document is determined (estimated) by performing line segment extraction processing on the captured image. Any method may be used for the line segment extraction processing (processing for extracting a line segment in an image). For example, a line segment (line segment list) is extracted by performing edge extraction and Hough transform on the captured image.

FIG. 6 is a diagram illustrating line segments extracted from a captured image, according to the present embodiment. As a result of the line segment extraction processing performed on the captured image by the candidate selection unit 45, line segments are extracted as indicated by thick lines in FIG. 6. The candidate selection unit 45 performs line segment extraction processing (analysis for determining the presence of a line segment) on the captured image, to estimate the presence of a ruled line in the read document on the basis of the result. Specifically, when the line segments are extracted as illustrated in FIG. 6 as a result of the line segment extraction processing, the candidate selection unit 45 estimates (determines) that a ruled line is present in the read document. When the candidate selection unit 45 estimates that a ruled line is present, the candidate selection unit 45 determines the color of a line segment corresponding to the ruled line (performs ruled line color analysis), to estimate the color of the ruled line included in the read document. The color of one line segment of the extracted line segments may be estimated as the color of the ruled line. Alternatively, the color of the ruled line may be estimated on the basis of the colors of the multiple extracted line segments. For example, color information of the line segments is converted to a histogram, and a color that appears most frequently is estimated as the color of the ruled line.

Subsequently, the selection unit 54 of the candidate selection unit 45 selects, from configurable setting values (setting values for RGB (values from 0 to 255)), a setting value corresponding to the image analysis result (i.e., the estimation result) as a candidate for the recommended setting. For example, when the candidate selection unit 45 estimates (determines) that a ruled line is present in the document as a result of the estimation, the candidate selection unit 45 selects a setting value corresponding to the color of the ruled line estimated on the basis of the colors of the extracted line segments as a candidate (candidate value) of the recommended setting for the dropout color item.

Some OCR systems use ruled lines for form recognition. In such a case, erasing a ruled line is not appropriate. For this reason, the system 9 may allow a user to select in advance whether to remove a ruled line (whether to set the color of a ruled line as a dropout color).

### Binarization Sensitivity and Noise Removal

Automatic binarization is image processing for binarizing an image while automatically adjusting a threshold value suitable for binarizing the image. The automatic binarization is a function of separating text from a background to obtain an image having a good contrast. An image processing setting item relating to a binarization sensitivity (in the following description, referred to as a “binarization sensitivity item”) is an item for setting the sensitivity (effect) of the automatic binarization, and is an item for removing background noise and clarifying characters. For example, when the effect (sensitivity) of the automatic binarization is too large, noise is likely to occur. When a large amount of noise occurs (in the case of a document for which noise is likely to occur in a captured image), a character recognition result for an image obtained by imaging the document may deteriorate due to the influence of noise. Accordingly, in order to obtain an image suitable for character recognition (an image with less noise), it is preferable to configure a setting for the binarization sensitivity item suitable for the document, such as reducing the sensitivity of automatic binarization (binarization sensitivity) when much noise occurs. Further, an image processing setting item relating to noise removal (noise reduction specification) (in the following description, referred to as “noise removal item”) is a setting item for image processing for removing an isolated point after binarization (automatic binarization) (performing fine adjustment when noise remains). For the same reason as the binarization sensitivity item, it is preferable to configure a setting for the noise removal item suitable for the document. Candidates for recommended settings for the binarization sensitivity item and the noise removal item can be selected by the Method 1.

First, the image analysis unit 51 of the candidate selection unit 45 performs image analysis (noise analysis) on a captured image to determine the amount of noise. The selection unit 54 of the candidate selection unit 45 can estimate the amount of noise that occurs when the read document is imaged as the feature of the read document on the basis of the result of the image analysis. The selection unit 54 of the candidate selection unit 45 selects setting values for the binarization sensitivity item and the noise removal item according to the result of the image analysis (the estimation result of the feature of the document) as candidates for the recommended settings for the binarization sensitivity item and the noise removal item. In the present embodiment, the noise analysis is performed on a binarized image of a captured image by the following method. In the present embodiment, by performing the noise analysis on the captured image (binarized image) on which image processing is performed with the candidate value for the background pattern removal item, candidate values for the binarization sensitivity item and the noise removal item corresponding to (to be combined with) the candidate value for the background pattern removal item are determined. However, the candidate values for the binarization sensitivity item and the noise removal item may be determined in a different manner from the above. The candidate values for the binarization sensitivity item and the noise removal item may be determined by performing the noise analysis described below on the binarized image of the captured image to estimate the amount of noise.

First, a user inputs a desired field (OCR area) for which the user wants character recognition to be performed in the read document and a correct character string written in the area in advance. On the basis of the user's input, the reception unit 32 acquires in advance the OCR area and the correct character string for the read document. Then, the candidate selection unit 45 calculates the number of black blocks (black connected pixel blocks), which are connected components, (in the following description, referred to as “the number of CCs”) in each of OCR areas in an image obtained by performing image processing (background pattern removal processing) based on the candidate value for the background pattern removal item on the captured image (binarized image). In other words, the candidate selection unit calculates the number of CCs for each of images (partial images) obtained by extracting the OCR areas of the image. When the candidate value for the background pattern removal item is “no background pattern removal,” the number of CCs is calculated in each of the OCR areas in the binarized image of the captured image on which the background pattern removal processing is not performed. Further, the candidate selection unit 45 calculates an expected value of the number of CCs in each of the OCR areas on the basis of the correct character string for the corresponding OCR area. The candidate selection unit 45 compares the calculated number of CCs with the expected value of the number of CCs, to estimate the amount of noise of the read document (the amount of noise that occurs when the read document is imaged).

The expected value of the number of CCs is calculated by either of the following two methods. In the first method, the calculation is performed using data including a collection of expected values of the number of CCs for characters (i.e., dictionary data of the number of CCs). The candidate selection unit 45 retrieves the expected values of the number of CCs for characters included in the correct character string from the dictionary data of the number of CC. Further, the candidate selection unit 45 calculates the expected value of the number of CCs for the OCR area by adding the expected values of the number of CCs retrieved for the characters. In the second method, the expected value of the number of CCs is calculated on the basis of the language of text for which character recognition is to be performed (i.e., the language of text in the OCR area) and the number of characters of the correct character string. The number of CCs per character is somewhat related to language. For example, the number of CCs is large for Chinese, and the number of CCs is small for English. For this reason, the candidate selection unit 45 sets a coefficient (weighting coefficient) per character for each language, and calculates the expected value of the number of CCs on the basis of the coefficient and the correct character string. For example, when the coefficient per character is set to 1.2 for English, the expected value of the number of CCs of the correct character string “abcde” is calculated as 6 (=1.2×5 (characters)). Further, for example, compared to the coefficient 1.2 which is set as the coefficient per character for English, a higher coefficient such as 2.5 is set for the coefficient per character for Chinese.

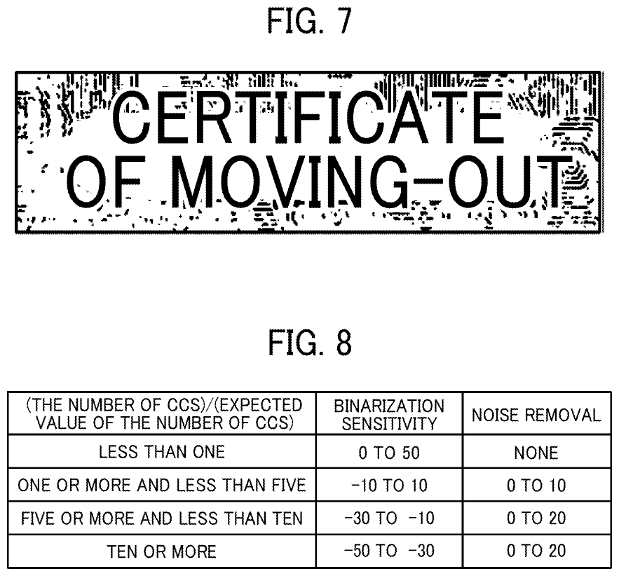

FIG. 7 is a diagram illustrating a binarized image (an image obtained by extracting an OCR area) of a captured image, according to the present embodiment. For the image of the OCR area illustrated in FIG. 7, the expected value of the number of CCs is calculated as, for example, 14, and the actual number of CCs is calculated as 1260. In this case, the candidate selection unit 45 compares the actual number of CCs with the expected value of the number of CCs and finds out that the number of CCs is much larger than the expected value of the number of CCs. Accordingly, the candidate selection unit 45 estimates (determines) that the amount of noise is large. For example, the candidate selection unit 45 may estimate the amount of noise by comparing a value obtained by the expression (the actual number of CCs) /(the expected value of the number of CCs) with a predetermined threshold value (one or more threshold values). For example, when the value obtained by the expression (the actual number of CCs)/(the expected value of the number of CCs) is less than 1, the candidate selection unit 45 estimates that no noise is present. When the value obtained by the expression (the actual number of CCs)/(the expected value of the number of CCs) is 1 or more and less than 5, the candidate selection unit 45 estimates that the amount of noise is small. When the value obtained by the expression (the actual number of CCs)/(the expected value of the number of CCs) is 5 or more and less than 10, the candidate selection unit 45 estimates that the amount of noise is moderate. When the value obtained by the expression (the actual number of CCs)/(the expected value of the number of CCs) is 10 or more, the candidate selection unit 45 estimates that the amount of noise is large. When multiple OCR areas are set, the candidate selection unit 45 compares, for example, the value obtained by the expression (the total value of the actual numbers of CCs in the multiple OCR areas)/(the total value of the expected values of the numbers of CCs in the multiple OCR areas) with a predetermined threshold value (one or more threshold values), to estimate the amount of noise. In this case, another representative value, for example, may be used instead of the total value.

Subsequently, the selection unit 54 of the candidate selection unit 45 selects a setting value corresponding to the image analysis result (i.e., the estimation result) from configurable setting values (e.g., the binarization sensitivity from—50 to 50) as a candidate for the recommended setting. For example, when the result of the estimation (determination) indicates that no noise occurs when the read document is imaged, the selection unit 54 selects a setting value of 0 or a setting value of the positive direction (i.e., a direction that makes a character stand out) as a candidate (candidate value) for the recommended setting for the binarization sensitivity item. For example, when the result of the estimation (determination) indicates that noise occurs when the read document is imaged, the selection unit 54 selects a setting value in the negative direction (i.e., a direction that eliminates noise) according to the estimated amount of noise as the candidate value.

FIG. 8 is a table of the setting values according to the estimated amount of noise, according to the present embodiment.

FIG. 8 illustrates values (ranges) obtained by the expression (the actual number of CCs)/(the expected value of the number of CCs), each being associated with setting values (candidates for the recommended setting). As illustrated in FIG. 8, the setting values of the binarization sensitivity item and the noise removal item according to the value obtained by the expression (the actual number of CCs)/(the expected value of the number of CCs), in other words, the estimated amount of noise are selected as candidates for the recommended settings of the respective items.

The above-described method of the noise analysis is one example, and any other methods may be used for the noise analysis. The description given above is of a case where, in the present embodiment, the candidates for the recommended settings of the binarization sensitivity item and the noise removal item are selected on the basis of the noise analysis. Alternatively, a candidate may be selected for only one of the candidate for the recommended setting of the binarization sensitivity item and the candidate for the recommended setting of the noise removal item.

The description given above is of a case where, in the present embodiment, among the items illustrated in FIG. 3, an image processing setting item relating to a character thickness, which is a setting item for performing fine adjustment when a character is blurred, is excluded from items for which candidate values of a recommended setting are to be selected (i.e., items for which the options are to be narrowed down). Alternatively, a candidate value may be selected for the image processing setting item relating to the character thickness. Further, when the candidate selection unit 45 selects a candidate only by the Method 1, the candidate selection unit 45 does not necessarily include the first image processing unit 52 and the first recognition result acquisition unit 53. By contrast, when the candidate selection unit 45 selects a candidate only by the Method 2, the candidate selection unit 45 does not necessarily include the image analysis unit 51.

### Recommended Setting Determination

As described above, the candidate selection unit 45 narrows down the multiple configurable setting values to one or more setting values (candidates) that can be the recommended setting (recommended values). In response, the recommended setting determination unit 46 determines a recommended setting by performing detailed adjustment (i.e., fine adjustment such as configuring a noise removal setting for removing all noise, leaving text, or customizing the setting according to an OCR engine, or fine adjustment of character thickness). Specifically, the recommended setting determination unit 46 tries image processing on a captured image (a read image or a processed image) multiple times with setting values of multiple setting items being changed from one to another for the setting item for which multiple configurable setting values are narrowed down (i.e., at least one setting item of the multiple setting items). The setting values used in trying the image processing are limited to the setting values selected as the candidates for the recommended setting by the candidate selection unit 45. Specifically, the recommended setting determination unit 46 determines the recommended settings for the multiple setting items on the basis of the character recognition results for multiple images obtained by trying the image processing multiple times on the captured image with the setting values of the multiple setting items being changed from one to another. In the present embodiment, in order to determine the recommended setting, the recommended setting determination unit 46 includes a second image processing unit 55, a second recognition result acquisition unit 56, and a determination unit 57.

The second image processing unit 55 performs (tries) image processing on the captured image. The second recognition result acquisition unit 56 acquires an image obtained as a result of the trial (i.e., the captured image on which the image processing has been performed) and a character recognition result (i.e., OCR result) for the captured image. The determination unit 57 determines a recommended setting on the basis of the character recognition result acquired by the second recognition result acquisition unit 56. The second recognition result acquisition unit 56 may acquire the character recognition result by performing character recognition processing (OCR processing). Alternatively, the second recognition result acquisition unit 56 may acquire the character recognition result from another apparatus that performs character recognition processing.

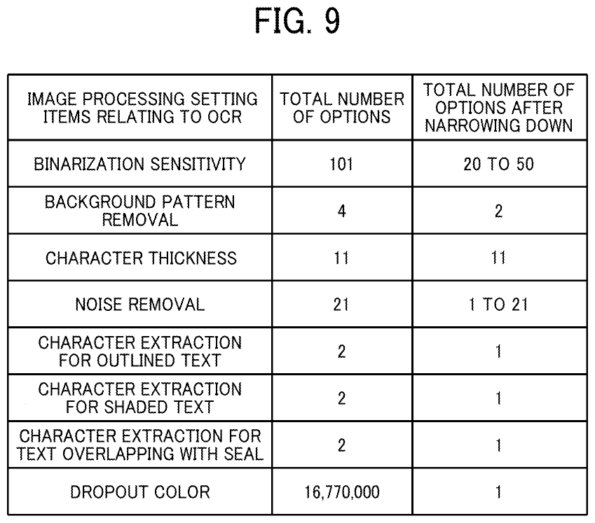

In the present embodiment, the recommended setting determination unit 46 first creates a combination table obtained by simply multiplying candidate values of multiple setting items (parameters) by using the candidate values of the recommended setting selected by the candidate selection unit 45. However, candidate values for the setting item relating to the size of character are not changed from configurable setting values for the setting item relating to the size of character. In the present embodiment, the candidate value for the binarization sensitivity item and the candidate value for the noise removal item are determined for each of the candidate values for the background pattern removal item. For this reason, when creating the combinations (combination table), the recommended setting determination unit 46 creates only combinations of the candidate values for the background pattern removal item and the candidate values for the binarization sensitivity item and the noise removal item corresponding to the candidate values for the background pattern removal item. In other words, the recommended setting determination unit 46 does not create combinations of the setting values of the background pattern removal item, the binarization sensitivity item, and the noise removal item other than the above created combinations. FIG. 9 is a table of the multiple setting items each being associated with options obtained by the process of narrowing down, according to the present embodiment. As illustrated in FIG. 9, the number of options for some of the setting items (i.e., the binarization sensitivity, the background pattern removal, the noise removal, the outlined character extraction, the shaded character extraction, the seal overlapping character extraction, and the dropout color) are reduced by the candidate selection process by the candidate selection unit 45. The candidate selection unit 45 creates (generates) all combinations (combination table) of the setting values of the multiple setting items by simply multiplying all the options (candidate values) obtained by the process of narrowing down for the multiple setting items. The generated combinations are combinations for performing the above-described detailed adjustment. When the number of combinations is enormous, the setting values (candidate values) may be further thinned out. For example, the candidate values of 0 to 50 for the binarization sensitivity may be thinned out to obtain setting values in increments of 5. The description given above is of a case where, in the present embodiment, the combination table is created. However, since it suffices as long as image processing and character recognition are performed for all the combinations, the creation of the combination table is optional.

Subsequently, the second image processing unit 55 of the recommended setting determination unit 46 performs (tries) image processing on the captured image for each of all the combinations including the setting values obtained by the process of narrowing down (i.e., all the combinations in the combination table). Then, the second recognition result acquisition unit 56 of the recommended setting determination unit 46 acquires character recognition results for images corresponding to the combinations (i.e., images obtained by performing image processing with the combinations). Then, the determination unit 57 of the recommended setting determination unit 46 determines a particular combination (i.e., a combination of the setting values for multiple setting items) with which an image with the best character recognition result (character recognition rate) is obtained as recommended settings for the multiple setting items. In the present embodiment, evaluation values (evaluation indices) based on the character recognition result are calculated for the character recognition results, and a combination with which the highest evaluation value is obtained is determined as the recommended setting.

A description is now given of the two methods (i.e., the Evaluation method 1 and the Evaluation method 2) for evaluating the character recognition result (i.e., for calculating the evaluation value).

### Evaluation Method 1

In the Evaluation method 1, a user inputs a desired field (OCR area) for which the user wants character recognition to be performed in a read document and a correct character string written in the area in advance. On the basis of the user's input, the reception unit 32 acquires in advance an OCR area and a correct character string for the read document. When the OCR area and the correct character string have been already acquired in the above-described process of selecting the candidates, such an OCR area and correct character string may be used. Subsequently, the recommended setting determination unit 46 determines whether a recognized character string which is the character recognition result acquired for the OCR area completely matches the correct character string for the corresponding OCR area for each of the OCR areas, and calculates the number of OCR areas (the number of fields) in which the recognized character string completely matches the correct character string. In the following description, the number of OCR areas in which the recognized character string and the correct character string completely match each other is referred to as a “field recognition rate.” Further, the recommended setting determination unit 46 calculates the number of matching characters (the number of matches between recognized characters and correct characters) between the recognized character strings for all the OCR areas and the correct character string for all the OCR areas. In the following description, the number of matches between the recognized characters and the correct characters (recognition rate for each character) is referred to as a “character recognition rate.”

For example, it is assumed that correct character strings for three OCR areas (OCR areas 1 to 3) in the read document (captured image) are “PFU Limited” for the OCR area 1, “INVOICE” for the OCR area 2, and “¥10,000” for the OCR area 3. Two results as character recognition results (recognized character strings) acquired when character recognition is performed on the three OCR areas are described for an illustrative purpose.

In the first character recognition result, it is assumed that the recognized character strings for the three OCR areas are “PFU Limited,” “INVOICE,” and “¥10,000.” In this case, since the recognized character string and the correct character string completely match each other in the OCR area 1 and the OCR area 2, the field recognition rate is calculated as 2/3. In the OCR area 3, “1” (the number “1”) is erroneously recognized as “I” (English letter “I”), and “0” (the number “0”) is erroneously recognized as “O” (English letter “O”) in the recognized character string. For other characters, the recognized characters and the correct characters match each other. Accordingly, the character recognition rate is calculated as 19/24.

In the second character recognition result, it is assumed that the recognized character strings for the three OCR areas are “PF Limited,” “INVOICE 1,” and “¥ 10, 000.” In this case, since the recognized character strings and the correct character strings do not completely match in all of the three OCR areas, the field recognition rate is calculated as 0/3. Further, for the OCR area 1, “U” is not recognized in the recognized character string. For the OCR area 2, “E” is erroneously recognized as “E 1.” For the OCR area 3, “1” (the number “1”) is erroneously recognized as “I” (English letter “I”). Accordingly, the character recognition rate is calculated as 21/24.

The recommended setting determination unit 46 determines (evaluates) the quality of the character recognition result on the basis of the field recognition rate and the character recognition rate which are the calculated evaluation values. For example, a method may be adopted in which a particular character recognition result is selected in the order of the highest field recognition rate and the highest character recognition rate. In this method, first, the field recognition rates of all the character recognition results are compared with each other, and a particular character recognition result having the highest field recognition rate is determined as the best character recognition result. When there are multiple OCR areas having the same field recognition rate, the character recognition rates for the multiple OCR areas are compared with each other, and a particular character recognition result having the highest character recognition rate is determined as the best character recognition result. When this method is used, regarding the above-described first character recognition result and second character recognition result, the first character recognition result which has a higher field recognition rate is determined as a better character recognition result. The method of determining the quality of the character recognition result on the basis of the field recognition rate and the character recognition rate is not limited to the above-described method, and any other method may be used. For example, a method may be used in which another evaluation value (evaluation index) is obtained on the basis of the field recognition rate and the character recognition rate and the quality of the character recognition result is determined on the basis of the obtained evaluation value.

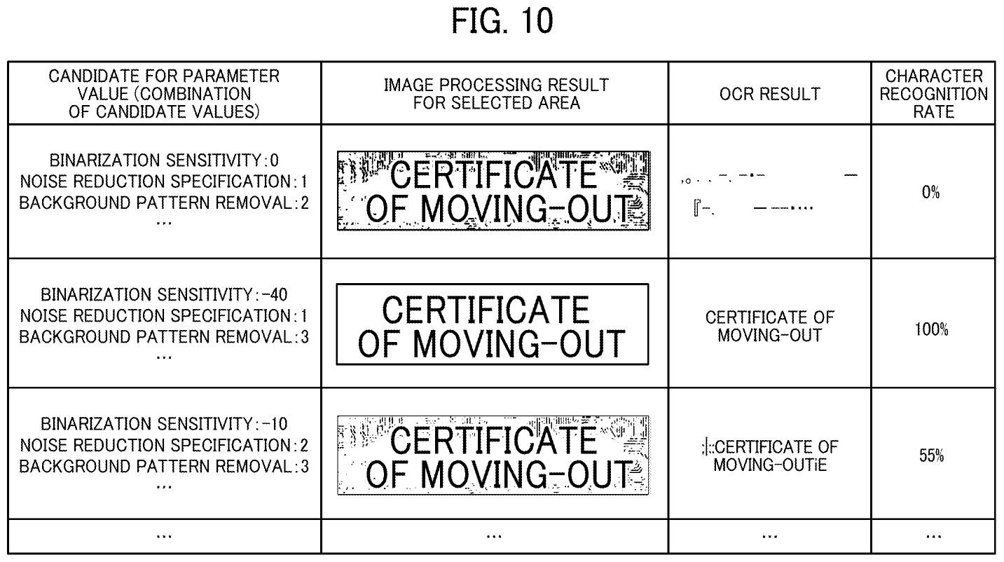

FIG. 10 is a table for describing the method of evaluating the character recognition result, according to the present embodiment. FIG. 10 illustrates, for each of combinations of setting values (candidate values) for multiple setting items, an image processing result (an image of a selected OCR area, which is an image on which image processing has been performed with the corresponding combination of the candidate values), an OCR result, and a character recognition rate. As illustrated in FIG. 10, the recommended setting determination unit 46 calculates the character recognition rates in the OCR areas for the multiple combinations, to determine a particular combination that provides the best character recognition result as a recommended setting. FIG. 10 illustrates only the character recognition rate for one OCR area. However, as described above, when multiple OCR areas are set, the character recognition rates and the field recognition rates for the multiple OCR areas are calculated, to determine a setting (i.e., the combination of candidate values) according to which the best character recognition result is obtained.

### Evaluation Method 2

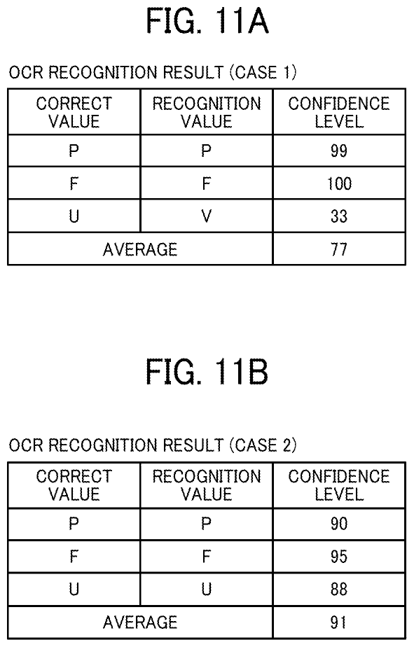

In the second method, an evaluation value is calculated on the basis of the confidence level of each character acquired from the OCR engine. FIG. 11A and FIG. 11B are tables for describing a method of calculating an evaluation value on the basis of the confidence level, according to the present embodiment. FIG. 11A is a table for describing a method of calculating an evaluation value for a character recognition result (Case 1), according to the present embodiment. FIG. 11B is a table for describing a method of calculating an evaluation value for a character recognition result (Case 2), according to the present embodiment. As illustrated in FIG. 11A and FIG. 11B, the evaluation value is calculated on the basis of the confidence levels obtained from the OCR engine for the character recognition result (recognition value) for characters (correct values) of the correct character string. In the example of FIG. 11A and FIG. 11B, the average value of the confidence levels of the characters is calculated as the evaluation value. The recommended setting determination unit 46 determines (evaluates) the quality of the character recognition result on the basis of the calculated evaluation value. For example, in the case of FIG. 11A, 77, which is the average value of the confidence levels of the characters, is calculated as the evaluation value. In the case of FIG. 11B, 91, which is the average value of the confidence levels of the characters, is calculated as the evaluation value. Accordingly, the character recognition result with a higher evaluation value (the Case 2) is determined as a better character recognition result. The evaluation value is not limited to the average value of the confidence levels of characters. For example, any other representative value may be used as the evaluation value.

When the captured image used for the analysis process in the candidate selection process is a read image (raw image), the captured image on which image processing is to be performed in the recommended setting determination process may be the read image used in the candidate selection process or may be an image obtained by performing image processing on the captured image (read image) used in the candidate selection process. Similarly, when the captured image on which image processing is performed (tried) in the recommended setting determination process is a read image (raw image), the captured image used in the analysis process in the candidate selection process may be a read image which is the captured image used in the recommended setting determination process, or may be an image obtained by performing image processing on the captured image (read image) used in the recommended setting determination process.

The storage unit 34 stores recommended settings (recommended values) for multiple setting items determined by the analysis unit 33. The storage unit 34 stores, for example, recommended settings for multiple setting items determined using a read document as a profile suitable for the read document. Thus, when the read document and the document of the same type as the read document are scanned thereafter, the scanning can be performed using the stored profile (i.e., the image processing setting suitable for the document can be performed).

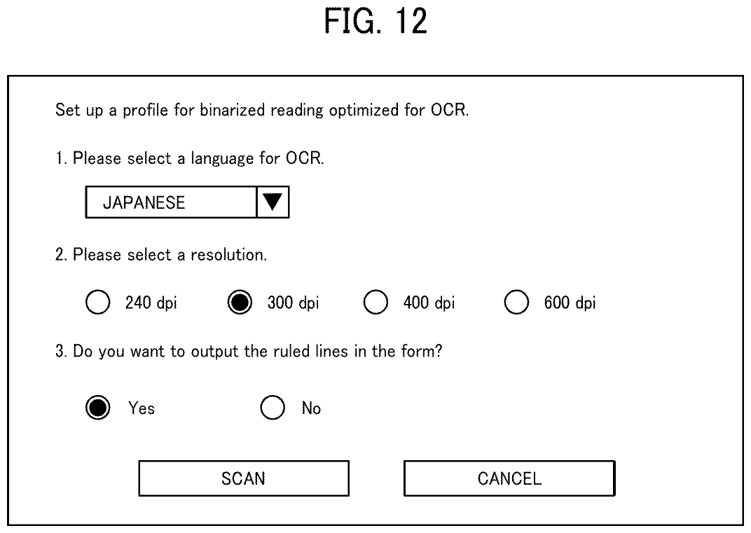

The presentation unit 35 presents (proposes), to a user, the recommended settings (the setting items and the recommended values determined for the setting items) for the multiple setting items determined by the analysis unit 33. Any suitable method may be used in presenting the recommended settings. For example, the recommended settings are presented by displaying a list of the recommended settings on, for example, a setting window via the output device 16. In addition to or in alternative to the above, for example, the recommended settings are presented by providing information regarding the recommended settings to a user via the communication unit 17. In addition to or in alternative to the above, for example, the recommended settings are presented by displaying information that prompts (proposes) a user to register (save) the recommended settings as a profile (a set of settings) to be used in the future. Further, when presenting the recommended settings to a user, the presentation unit 35 may present (display), to the user, an image reflecting the recommended settings or a character recognition result (OCR result) of an image reflecting the recommended settings. A description is now given of examples of windows, which are user interfaces (UIs) for presenting the recommended settings to a user by the presentation unit 35. In the following, windows of a case where a user is prompted to input in advance an OCR area to be recognized and a correct character string and the analysis process is performed using the OCR area and the correct character string are described for an illustrative purpose. FIG. 12 is a diagram illustrating a pre-setting window, according to the present embodiment. On the pre-setting window, which is a window displayed when the recommended setting determination process starts, pre-settings for performing the recommended setting determination process are configured according to an operation by a user. The window illustrated in FIG. 12 allows the user to select (set), as the pre-settings, a language to be subjected to character recognition (OCR) (e.g., Japanese, English, or Chinese), a reading resolution (e.g., 240 dpi, 300 dpi, 400 dpi, or 600 dpi), and whether to output an image excluding ruled lines in a form (i.e., whether to erase the ruled lines). The window illustrated in FIG. 12 is displayed, for example, in response to the presentation unit 35 receiving an instruction to create a profile suitable for character recognition (i.e., an instruction to determine a recommended setting) according to an operation by the user. In response to pressing of a button (“SCAN” button) for acquiring a scanned image (captured image) by the scanner 8 by the user after the pre-settings are configured with the window illustrated in FIG. 12, the scanner 8 reads the read document to acquire the captured image. On the other hand, in response to pressing of a “CANCEL” button by the user, the recommended setting determination process ends, and the pre-setting window is closed (hidden).

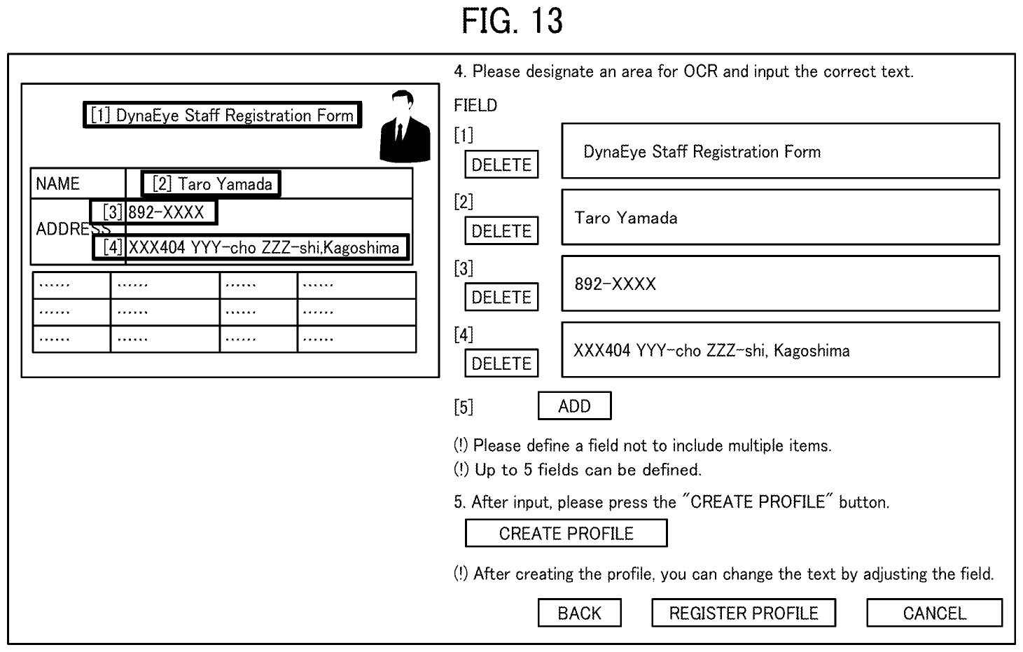

FIG. 13 is a diagram illustrating a recommended setting determination window, according to the present embodiment. The window illustrated in FIG. 13 is a window displayed when the captured image is acquired as a result of the pressing of the “SCAN” button by the user on the window of FIG. 12. As illustrated in FIG. 13, the acquired captured image is displayed on the recommended setting determination window. FIG. 13 illustrates a case where a scanned image (captured image) corresponding to a single-sheet document is acquired. Alternatively, when a multiple-sheet document is read, multiple scanned images (multiple captured images) corresponding to the multiple-sheet document are displayed on the recommended setting determination window. The user designates an area for which the user wants character recognition to be performed on the window displaying the acquired captured image as illustrated in FIG. 13 (see four bold frames in the drawing). Further, on the window of FIG. 13, the user inputs correct character strings for the designated areas (i.e., a correct character string written in the areas) (see fields [1] to [4] in the drawing). In response to the pressing of a button (“CREATE PROFILE” button) for performing the recommended setting determination process by the user after the designation of the areas to be subjected to character recognition and the input of the correct character strings for the areas are completed, the recommended setting determination process starts. Further, as illustrated in FIG. 13, the recommended setting determination window displays a button (“REGISTER PROFILE” button) for registering (saving) the recommended settings (profile). In response to pressing of the button by the user, the recommended settings (profile) are registered. When the user presses a “CANCEL” button on the window illustrated in FIG. 13, the recommended settings are not registered.

In this case, the recommended setting determination process (profile creation process) may be performed again in response to the change (e.g., addition) of an OCR area according to an operation by the user and pressing of the “CREATE PROFILE” button again by the user. Further, in response to pressing of a “BACK” button by the user on the window illustrated in FIG. 13, the pre-setting window illustrated in FIG. 12 is displayed, to allow the process of acquiring a captured image to be performed again.

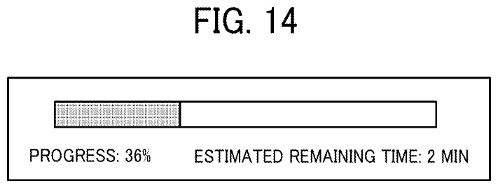

FIG. 14 is a diagram illustrating a progress display window, according to the present embodiment. The window illustrated in FIG. 14 is displayed in response to pressing of the “CREATE PROFILE” button by the user on the window of FIG. 13. As illustrated in FIG. 14, when the analysis process is being executed by the analysis unit 33, progress information, which is information indicating that the analysis process is being executed and/or information indicating the progress of the analysis process is displayed on the progress display window. FIG. 14 illustrates the progress display window on which the text “PROGRESS: 36%” and a progress bar are displayed as information indicating the progress (e.g., 36% of 100% has been completed). Further, FIG. 14 illustrates the progress display window on which the text “ESTIMATED REMAINING TIME: 2 MIN” is displayed as an estimated time of a remaining time until the analysis process ends. The window illustrated in FIG. 14 may be closed (hidden) when the profile creation (determination of the recommended value) is completed. Further, when the profile creation (determination of the recommended value) is completed, the character recognition result of an image reflecting the recommended setting (e.g., a captured image on which image processing is performed with the recommended setting) may be displayed on, for example, the window illustrated in FIG. 13 or FIG. 14.

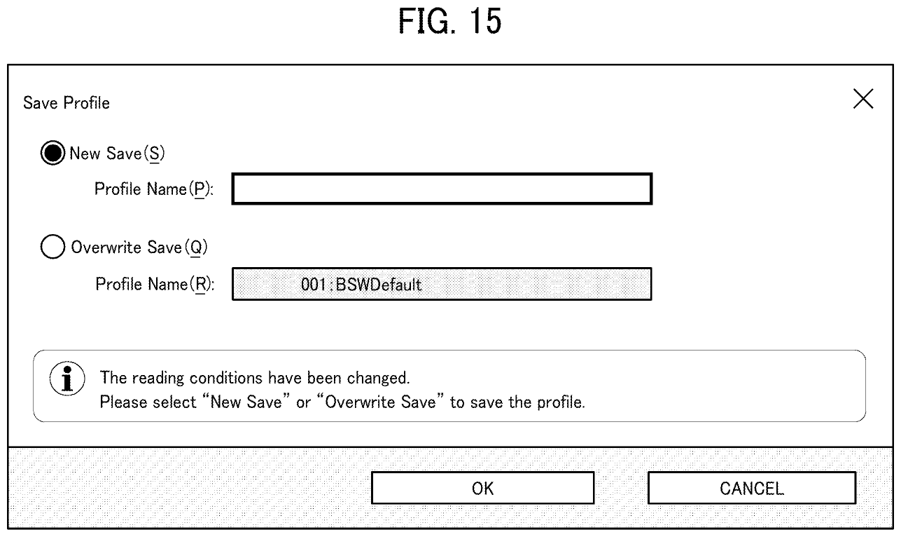

FIG. 15 is a diagram illustrating a recommended setting saving window, according to the present embodiment. The window illustrated in FIG. 15 is displayed in response to pressing of the “REGISTER PROFILE” button by the user on the window illustrated in FIG. 13. As illustrated in FIG. 15, the recommended setting saving window displays, for example, a display (e.g., button) for newly saving the recommended settings (profile) and a display (e.g., button) for overwriting the recommended settings (profile). The user can select whether to newly save or overwrite the recommended settings (profile) determined by the analysis process on the window illustrated in FIG. 15, and then save the recommended setting. In response to pressing of an “OK” button by the user on the window illustrated in FIG. 15, a profile (driver profile) including the recommended settings determined by the analysis process is registered (stored) in the storage device 14. This allows the user to instruct to perform scan processing (image processing) using the registered profile (set of settings). Thus, an image suitable for character recognition is obtained. The profile thus registered can be used not only in scan processing for the read document read according to the operation on the window of FIG. 12 but also in the scan processing of a document of the same type as the read document (e.g., the same type of form). In response to pressing a “CANCEL” button on the window illustrated in FIG. 15, the process of registering the recommended settings ends, and the recommended setting saving window is closed (hidden).

The description given above is of a case where, in the present embodiment, the presentation unit 35 generates and displays the recommended setting generation window. Alternatively, instead of the presentation unit 35, a display control unit that presents the recommended setting may generate and display the recommended setting generation window.

### Process

A description is now given of a process performed by the information processing system according to the present embodiment.

The specific content of process and processing order described below are examples for implementing the present disclosure. The specific processing content and processing order may be appropriately selected according to the mode of implementation of the present disclosure.

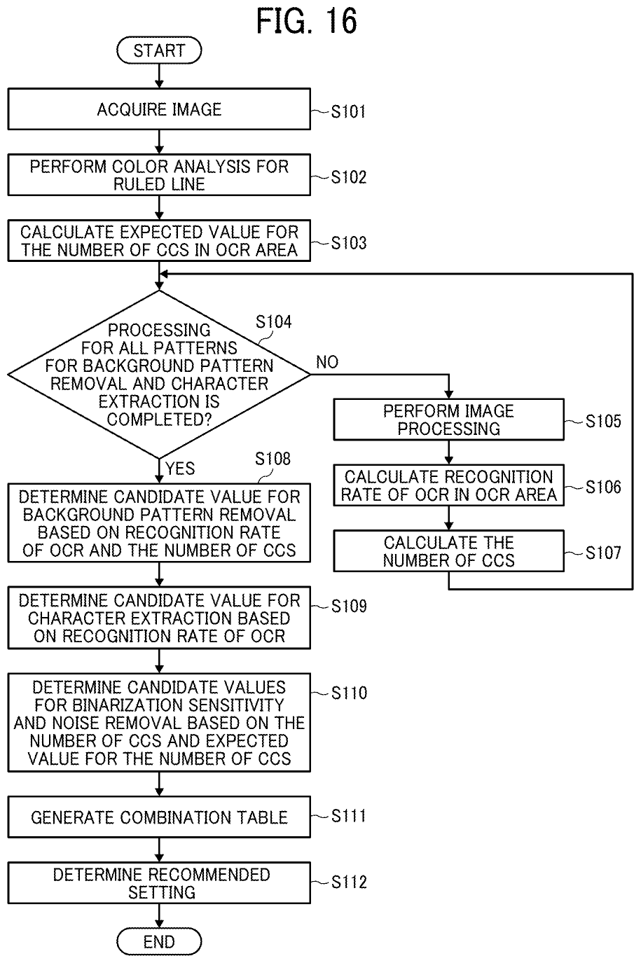

FIG. 16 is a flowchart of a process for determining a recommended setting, according to the present embodiment. The process illustrated in the flowchart starts, for example, in response to the information processing apparatus 1 receiving an instruction to determine a recommended setting from a user. In response to receiving the instruction from the user, the presentation unit 35 causes the output device 16 (displaying means) to display the pre-setting window (see FIG. 12). In the process illustrated in the flowchart, candidate values for the background pattern removal are determined by the above-described Method 2 (unit verification).

In step S101, an image is acquired. For example, the image acquisition unit 31 acquires a captured image of a read document by reading the read document in response to pressing of the “SCAN” button by a user on the window illustrated in FIG. 12. Further, it is assumed that areas (OCR areas) for which the user wants character recognition to be performed, correct character strings corresponding to the OCR areas, and an OCR language have been input to be obtained by the reception unit 32 before the processing of step S101. The process then proceeds to step S102.

In step S102, color analysis for a ruled line is performed. The analysis unit 33 performs analysis for determining whether a ruled line is present in the captured image acquired in step S101. When the analysis unit 33 determines that a ruled line is present, the analysis unit 33 estimates the color of the ruled line included in the read document (captured image) by performing color analysis for the ruled line. Thus, the analysis unit 33 determines a candidate value (candidate for a parameter value) for the dropout color item. The process then proceeds to step S103.

In step S103, an expected value of the number of CCs for each of the OCR areas is calculated. The analysis unit 33 calculates, for example, an appropriate number of the number of CCs (the expected value of the number of CCs) for each of the OCR areas, based on the number of characters of the correct character string and the OCR language. The process then proceeds to step S104.

In step S104, whether the processing for all patterns for background pattern removal and character extraction is completed (executed) is determined. For example, the analysis unit 33 determines whether processing (image processing in step S105 described below is completed for seven patterns, which are all patterns for background pattern removal (four patterns, that is, no background pattern removal and level 1 to level 3) and all patterns for character extraction (three patterns, that is, the outlined character extraction ON, the shaded character extraction ON, and the seal overlapping character extraction ON). The analysis unit 33 also determines whether OCR recognition rate calculation in step S106 described below is completed. The analysis unit 33 also determines whether CC number calculation in step S107 described below is completed. When the analysis unit 33 determines that the processing for all the patterns is completed (YES in step S104), the process proceeds to step S108. By contrast, when the analysis unit 33 determines that the processing for all the patterns is not completed (NO in step S104), the process proceeds to step S105.

In step S105, image processing relating to background pattern removal or character extraction is performed. The analysis unit 33 performs image processing on the captured image acquired in step S101 for a pattern for which the analysis unit 33 determines in step S104 that the image processing is not completed. For example, when processing for “background pattern removal level 4” is not completed, image processing (background pattern removal processing) with the setting value of the background pattern removal level 4 is performed. Further, for example, when processing for “seal overlapping character extraction ON” is not completed, image processing (seal overlapping character extraction processing) with the setting value of the seal overlapping character extraction ON is performed. No image processing has to be performed for “no background pattern removal.” The process then proceeds to step S106.

In step S106, an OCR recognition rate is calculated. The analysis unit 33 acquires a character recognition result for the captured image (the OCR areas) on which the image processing is performed in step S105. An image corresponding to “no background pattern removal” is the captured image acquired in step S101. Accordingly, in the case of “no background pattern removal,” the analysis unit 33 acquires the character recognition result for the captured image (the OCR areas) acquired in step S101. Then, the analysis unit 33 calculates the OCR recognition rate (e.g., the field recognition rate, the character recognition rate) on the basis of the character recognition result (i.e., recognized character string) for each of the OCR areas. Various methods may be used to calculate the OCR recognition rate. The process then proceeds to step S107.

In step S107, the number of CCs is calculated. The analysis unit 33 calculates the number of CCs for the captured image (the OCR areas) on which the image processing is performed in step S105. An image corresponding to “no background pattern removal” is the captured image acquired in step S101. Accordingly, in the case of “no background pattern removal,” the analysis unit 33 acquires the number of CCs for the captured image (the OCR areas) acquired in step S101. In step S107, while the number of CCs is calculated for each of the patterns of background pattern removal (the number of CCs for an image corresponding to each of the settings for the background pattern removal), the number of CCs is not calculated for each of the patterns of character extraction (an image corresponding to each of the settings for character extraction). In other words, when the image processing performed in step S105 is image processing relating to character extraction, the process of calculating the number of CCs in step S107 is omitted. The process then returns to step S104.

In steps S108 to S110, candidate values of some parameters are determined. In other words, parameter value candidates are selected. In step S108, a candidate value (parameter value candidate) for the background pattern removal item is determined on the basis of the OCR recognition rate and the number of CCs. In the present embodiment, the analysis unit 33 compares the OCR recognition rates calculated in step S106 and the numbers of CCs calculated in step S107 between all of the patterns (setting values) for the background pattern removal item, and selects a predetermined number (e.g., two) of setting values (patterns) which are favorable in the order of the OCR recognition rate and the number of CCs as candidate values. Alternatively, the candidate value may be selected by comparing only the OCR recognition rates between all of the patterns. When the OCR recognition rates and the numbers of CCs are compared between the patterns, the OCR recognition rates and the numbers of CCs in all the OCR areas are to be considered. For example, the representative values (e.g., average values), the total values, or a combination of these of the numbers of CCs calculated for the OCR areas are compared between the patterns. The process then proceeds to step S109.

In step S109, a candidate value (parameter value candidate) for the character extraction item is determined on the basis of the OCR recognition rate. In the present embodiment, the analysis unit 33 compares the OCR recognition rates between the case where the setting for the character extraction is ON and the case where the setting for the character extraction is OFF, and determines whether the recognition rate rises when the setting for the character extraction is ON, to determine the candidate value (ON or OFF) relating to the character extraction. For example, the analysis unit 33 compares the OCR recognition rate calculated in step S106 for the case of “outlined character extraction ON” with the OCR recognition rate calculated in step S106 for the case of “outlined character extraction OFF.” When the recognition rate is higher (rises) in the case of “outlined character extraction ON,” the analysis unit 33 determines the candidate value (setting value) for the “outline character extraction” as “ON.” The “OCR recognition rate calculated in step S106 for the case of “character extraction OFF”” is an OCR recognition rate calculated for the image acquired in step S101. Accordingly, the OCR recognition rate calculated in step S106 for the pattern of “no background pattern removal” (i.e., when all of the character extraction settings are OFF) may be used. When the OCR recognition rates are compared, the OCR recognition rates in all of the OCR areas are to be considered. The process then proceeds to step S110.

In step S110, candidate values (parameter value candidates) for the binarization sensitivity item and the noise removal item are determined on the basis of the number of CCs and the expected value of the number of CCs. The analysis unit 33 determines candidate values for the binarization sensitivity item and the noise removal item corresponding to the candidate values for the background pattern removal item determined in step S108. For example, it is assumed that the candidate values for the background pattern removal item are determined as “Level 1” and “Level 2” in step S108. In this case, the analysis unit 33 compares the number of CCs calculated in step S107 when the image processing (background pattern removal processing) is performed with the setting value “Level 1” in step S105 with the expected value of the number of CCs calculated in step S103, to determine candidate values for the binarization sensitivity item and the noise removal item corresponding to “Level 1.” For example, the analysis unit 33 determines the candidate value for the binarization sensitivity item as “−10 to 10” and the candidate value for the noise removal item as “0 to 10.” In substantially the same manner, the analysis unit 33 compares the number of CCs calculated in step S107 when the image processing (background pattern removal processing) is performed with the setting value “Level 2” in step S105 with the expected value of the number of CCs calculated in step S103, to determine candidate values for the binarization sensitivity item and the noise removal item corresponding to “Level 2.” For example, the analysis unit 33 determines the candidate value for the binarization sensitivity item as “−30 to −10” and the candidate value for the noise removal item as “0 to 20.” In this way, the analysis unit 33 compares the calculated number of CCs with the expected value of the number of CCs for each of the candidate values for the background pattern removal item, to determine the candidate values for the binarization sensitivity item and the noise removal item corresponding to each of the candidate values for the background pattern removal item.

When determining the candidate values for the binarization sensitivity item and the noise removal item corresponding to “no background pattern removal,” the analysis unit 33 compares the number of CCs calculated in step S107 for the pattern of “no background pattern removal” (i.e., in the case where all of the character extraction settings are OFF) with the expected value of the number of CCs. When the number of CCs is compared with the expected value of the number of CCs, the numbers of CCs and the expected values of the number of CCs in all of the OCR areas are to be considered. For example, the total value of the numbers of CCs calculated for the OCR areas are compared with the total value of the expected values of the number of CCs calculated for the OCR areas. The process then proceeds to step S111.

In step S111, combinations (combination table) are generated. The analysis unit 33 generates combinations (combination table) of setting values (candidate values) of multiple parameters by simply multiplying candidate values of the multiple parameters (all of the parameters) using the candidate values determined in step S102 and steps S108 to S110. The process then proceeds to step S112.

In step S112, recommended settings are determined. The analysis unit 33 determines recommended settings for the multiple setting items by performing image processing on the captured image acquired in step S101 using each of the combinations generated in step S111. Then, the process illustrated in the flowchart ends.

The image processing for all the patterns for the background pattern removal and the image processing for all the patterns for the character extraction may be performed at different times. For example, after the image processing for all the patterns of the background pattern removal is performed and the candidate value for the background pattern removal is determined, the image processing for all the patterns of the character extraction is performed and the candidate value for the character extraction is determined. Further, the processing of step S106 and step S107 may be performed in any order. Furthermore, the processing of step S108 and step S109 may be performed in any order.

In the present embodiment, when a user is not satisfied with (dissatisfied with) the proposal of the image processing settings (presentation of the recommended settings) by the presentation unit 35, the analysis unit 33 performs the above-described analysis process again with, for example, the OCR area being changed, to again determine image processing settings (recommended settings) suitable for OCR. The presentation unit 35 again presents the image processing settings (recommended settings) thus determined again to a user. Further, these processes may be repeated until a result (character recognition result) satisfying the user is obtained. Thus, image processing settings having higher accuracy are configured. In a case where the changed OCR areas include a newly set OCR area, a correct character string corresponding to the newly set OCR area is input in advance according to an operation by a user to be received by the reception unit 32 before the above-described analysis process is performed.

As described, the system 9 according to the present embodiment selects a candidate (a setting value) of a recommended setting by performing an analysis process using a captured image. The system 9 according to the present embodiment determines recommended settings for multiple setting items by repeatedly trying image processing on the captured image with setting values of the multiple setting items being changed from one to another, while limiting to the setting value selected as the candidate for the recommended setting (i.e., an image processing setting that makes an obtained image suitable for character recognition). Thus, an image processing setting with which an image suitable for character recognition processing can be obtained is determined in a simple manner. With this configuration, an image processing setting configuration achieving higher accuracy (higher recognition accuracy) is determined in advance according to a document. In other words, a profile achieving higher accuracy (higher recognition accuracy) is generated in advance. Further, according to the present embodiment, even a user who is not an expert (a user who does not understand image processing parameters) can configure a setting (scan setting) suitable for a document and optimal for character recognition (OCR) only by operating the scanner 8 to scan the document. Furthermore, according to the present embodiment, since a setting value (parameter value) optimal for character recognition is determined by actually using the character recognition result, the setting value (image processing parameter value) suitable for character recognition is obtained reliably. Moreover, since the generation of the combination and the trial of the image processing are performed after narrowing down configurable setting values to one or more setting values (i.e., after selecting one or more candidate values), the determination of the recommended setting is performed in a realistic amount of time. Thus, a desirable result is obtained in such an amount of time.

The description given above is of a case where, in the present embodiment, a single-sheet document (one type of document) is read, to determine a recommended setting suitable for the document. Thus, even when a large-number-sheet documents (e.g., fixed forms) of the same type as the document are scanned, image processing using the determined recommended setting can be performed in each of the scans. However, in a site where a high-volume scanning is performed, a case where not only one type of document but also multiple types of documents (forms) are scanned at a time (a case of mixed scanning) is also assumed. Also in such a case, it is preferable that image processing using a recommended setting suitable for a document is performed in each of scans. A description is now given of two methods for dealing with such a case.

The first method is to combine the above-described process of determining a recommended setting with an automatic profile selection function (known function) that uses ruled line information. In this method, first, the image acquisition unit 31 acquires multiple captured images (captured images corresponding to multiple types of documents) that are obtained by capturing images of the multiple types of documents (a multiple-sheet document). Then, recommended settings (optimum profiles) are determined for the multiple sheets (the multiple types of documents) by the above-described method, and the determined recommended settings (profiles) are registered for the multiple sheet (the multiple types of documents), respectively. In this case, the storage unit 34 may store, for each of the multiple sheets, the recommended settings in association with identification information of the corresponding document. Then, when configuring settings for scan, an automatic profile selection function is enabled, and information for identifying the document (e.g., ruled line information) is registered. The automatic profile selection function is a function of identifying a document and selecting (using) a profile (setting information) registered for the identified document. During operation, an imaged document is identified on the basis of the captured image and the registered document identification information. A particular profile that is registered for the identified document is selected on the basis of the document identification information. Scanning (image processing) is performed according to the profile. As a result, even in the case of mixed loading, scanning (image processing) can be performed according to a recommended setting suitable for each of multiple document (document type), and thus an image suitable for character recognition can be obtained.

The second method is to determine (propose) one recommended setting (profile) applicable to any type of document. In this method, first, the image acquisition unit 31 acquires multiple captured images (captured images corresponding to multiple types of documents) that are obtained by capturing images of the multiple types of documents (a multiple-sheet document). Then, by the above-described method, for each of the multiple types of documents (for each of the captured images), the candidate selection process (narrowing down of the setting values), the creation of the combinations (combination table) of the setting values based on the selected candidate values, and the calculation of the evaluation value for each of the combinations (the evaluation value for the character recognition result corresponding to each of the combinations) are performed. Then, a particular combination according to which the highest evaluation value is obtained for all of the multiple types of documents is determined as a recommended setting (profile) applicable to the multiple types of documents. As a result, even in the case of mixed scanning, scanning (image processing) can be performed according to a recommended setting applicable to the multiple types of documents, and thus an image suitable for character recognition can be obtained.

The description given above is of a case where, in the present embodiment, a document of a single sheet is read, to determine a recommended setting suitable for the document. Alternatively, by using a multiple-sheet document having a predetermined format (i.e., multiple document sheets of the same type), a recommended setting suitable for a document having the predetermined format may be determined. In this case, the image acquisition unit 31 acquires multiple captured images for the multiple-sheet document. From among the acquired multiple captured images, a captured image used for selecting one or more candidate values in the candidate selection process may be different from a captured image on which image processing is tried in the recommended setting determination process. For example, the candidate selection process may be performed using the captured image of the first sheet of the document, and the recommended setting determination process may be performed using the captured image of the second sheet of the document.

### Embodiment 2

In Embodiment 1, the information processing apparatus 1 including the driver (the read image processing unit 42) for the scanner 8 performs the analysis process. However, the configuration of the system 9 is not limited to this configuration. An information processing apparatus that is communicably connected to the information processing apparatus 1 and does not include the driver for the scanner 8 may perform the analysis process. In the present embodiment, a case where an information processing apparatus (e.g., a server) that does not include the driver for the scanner 8 performs the analysis process is described for an illustrative purpose.

### System Configuration

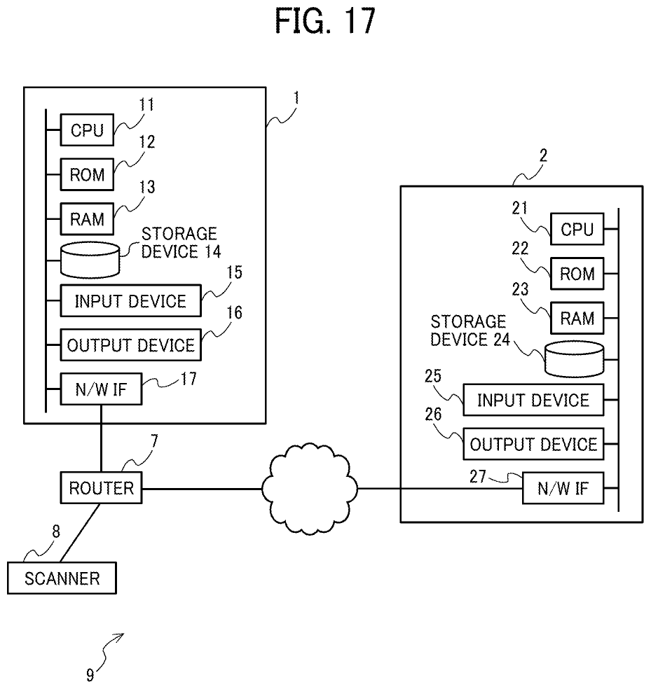

FIG. 17 is a schematic diagram illustrating a configuration of the system 9 according to the present embodiment. The system 9 according to the present embodiment includes the scanner 8, the information processing apparatus 1, and a server 2, which are communicably connected to one other through a network or other communication means. In FIG. 17, the information processing apparatus 1 is connected to the scanner 8 via a router (or gateway) 7. FIG. 17 illustrates a case where one scanner 8 and one information processing apparatus 1 are connected to the server 2. Alternatively, multiple scanners 8 and multiple information processing apparatuses 1 may be connected to the server 2.

The configurations of the scanner 8 and the information processing apparatus 1 are substantially the same as those of the scanner 8 and the information processing apparatus 1 in the above-described embodiment, and thus redundant descriptions thereof are omitted.

The server 2 acquires a captured image acquired by the information processing apparatus 1 and performs an analysis process using the captured image, to determine the above-described recommended setting. The server 2 is a computer including a CPU 21, a ROM 22, a RAM 23, a storage device 24, an input device 25, an output device 26, and a communication unit 27. Regarding the specific hardware configuration of the server 2, any component may be omitted, replaced, or added as appropriate according to a mode of implementation. Further, the server 2 is not limited to an apparatus having a single housing. The server 2 may be implemented by a plurality of apparatuses using, for example, a so-called cloud or distributed computing technology.

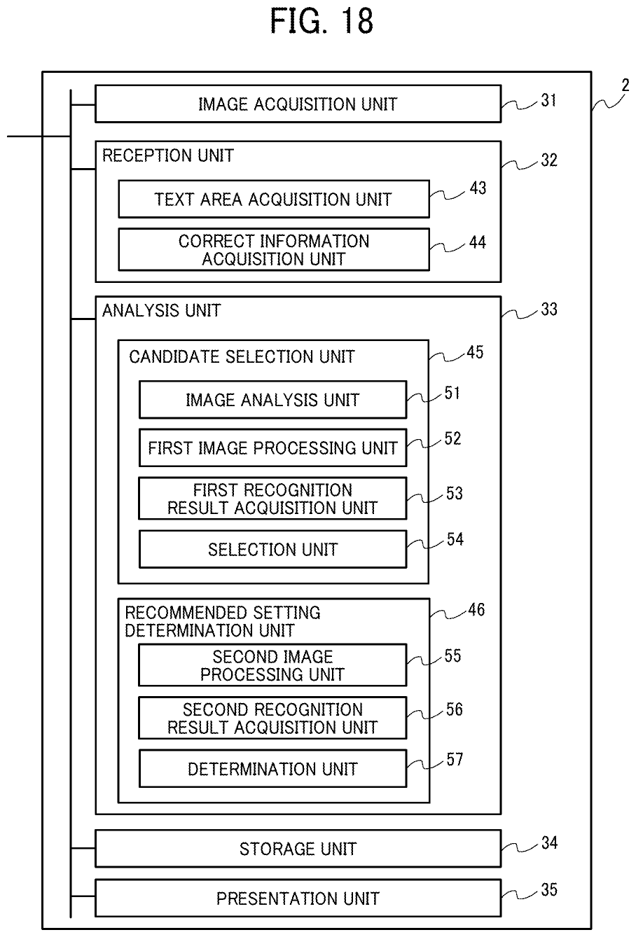

FIG. 18 is a schematic diagram illustrating a functional configuration of the server 2, according to the present embodiment. The CPU 21 executes a program that is loaded onto the RAM 23 from the storage device 24, to control the hardware components of the server 2 according to the program. Thus, the server 2 functions as an apparatus including the image acquisition unit 31, the reception unit 32, the analysis unit 33, the storage unit 34, and the presentation unit 35. The analysis unit 33 includes the candidate selection unit 45 and the recommended setting determination unit 46. In the present embodiment and other embodiments described below, the functions of the server 2 are executed by the CPU 21, which is a general-purpose processor. Alternatively, a part or all of these functions may be executed by one or a plurality of dedicated processors. The functional configuration (the functional units) of the server 2 is substantially the same as the functional configuration (the functional units) of the information processing apparatus 1 in Embodiment 1, and thus a redundant description thereof is omitted. However, in the present embodiment, the image acquisition unit 31 acquires a captured image from the information processing apparatus 1 through a network. Alternatively, in the present embodiment, the image acquisition unit 31 may acquire the captured image by reading the captured image stored in the storage device 24. Further, in the present embodiment, the reception unit 32 acquires the OCR area that is designated according to an operation by a user at the information processing apparatus 1 and the correct character string that is input according to an operation by a user from the information processing apparatus 1. Furthermore, in the present embodiment, the presentation unit 35 may present a recommended setting and/or a captured image reflecting the recommended setting to a user by transmitting the recommended setting and/or the captured image to the information processing apparatus 1.

### Embodiment 3

In Embodiment 1, the information processing apparatus 1 including the driver of the scanner 8 performs the analysis process. However, the configuration of the system 9 is not limited to this configuration. For example, the scanner 8 may perform the analysis process. In the present embodiment, a case where the scanner 8 performs the analysis process is described for an illustrative purpose.

### System Configuration

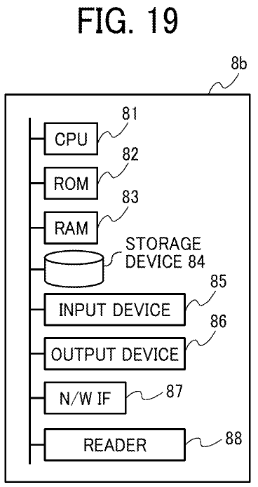

FIG. 19 is a schematic diagram illustrating a configuration of the system 9 according to the present embodiment. The system 9 according to the present embodiment includes a scanner 8b. The configuration of the scanner 8b is substantially the same as that of Embodiment 1, and thus a redundant description thereof is omitted. The scanner 8b is a computer (information processing apparatus) including a CPU 81, a ROM 82, a RAM 83, a storage device 84, an input device 85, an output device 86, a communication unit 87, and a reading unit 88. The reading unit 88 is a unit to read a document (document image) by an imaging sensor, and serves as an image reading means. Regarding the specific hardware configuration of the scanner 8b, any component may be omitted, replaced, or added as appropriate according to a mode of implementation.

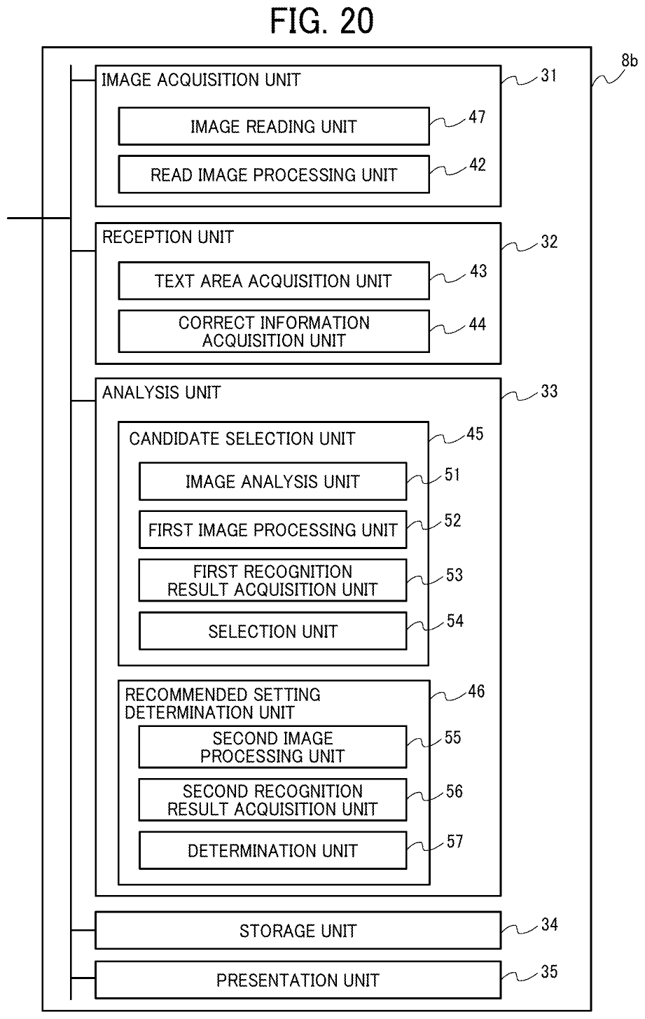

FIG. 20 is a schematic diagram illustrating a functional configuration of the scanner 8b, according to the present embodiment. The CPU 81 executes a program that is loaded onto the RAM 83 from the storage device 84, to control the hardware components of the scanner 8b according to the program. Thus, the scanner 8b functions as an apparatus including the image acquisition unit 31, the reception unit 32, the analysis unit 33, the storage unit 34, and the presentation unit 35. The analysis unit 33 includes the candidate selection unit 45 and the recommended setting determination unit 46. In the present embodiment, the functions of the scanner 8b are executed by the CPU 81, which is a general-purpose processor. Alternatively, a part or all of these functions may be executed by one or a plurality of dedicated processors.

The functional configuration (the functional units) of the scanner 8b is substantially the same as the functional configuration (the functional units) of the information processing apparatus 1 in Embodiment 1, and thus a redundant description thereof is omitted. However, in the present embodiment, the image acquisition unit 31 includes an image reading unit 47 as an image reading means and the read image processing unit 42 as an image reading means. The image reading unit 47 reads a document (an image of the document) by the imaging sensor. The read image processing unit 42 performs image processing on a read image generated by reading the document by the image reading unit 47. Thus, the image acquisition unit 31 acquires a captured image. Further, in the present embodiment, the presentation unit 35 may present a recommended setting and/or a captured image reflecting the recommended setting to a user by displaying the recommended setting and/or captured image reflecting the recommended setting on, for example, a touch panel of the scanner 8b.

### Embodiment 4

In Embodiment 4, a description is given of an embodiment of a case where an information processing system, an information processing apparatus, a method, and a program according to the present disclosure are implemented in a system that evaluates whether image processing to be evaluated is image processing suitable for character recognition (i.e., image processing suitable for acquiring an image suitable for character recognition). However, the information processing system, the information processing apparatus, the method, and the program according to the present disclosure can be widely used for a technology for evaluating a character recognition result (character recognition accuracy), and what the present disclosure is applied to is not limited to those described in the embodiments of the present disclosure.

As known in the art, an OCR engine performs character recognition processing on an image obtained by reading a document by an image reading apparatus. However, the OCR engine sometimes makes mistakes in reading. Accordingly, the character recognition rate of the OCR engine is not 100%. For this reason, a user compares an OCR result (recognized character string) with the correct text (correct character string) to check whether the OCR result is correct. However, even when there is a difference between the recognized character string and the correct character string, if the characters having the difference are similar characters, the user may erroneously determine that the characters are the same. When the user makes such an erroneous determination, the OCR result is not evaluated correctly.

In view of the above, the information processing system, the information processing apparatus, the method, and the program according to the present embodiment control the display of a window (i.e., a window displaying a result of collation between a correct character string and a recognized character string) for checking a character recognition result of an image on which image processing to be evaluated is performed to vary according to the result of the collation. The window allows a user to evaluate whether the image processing to be evaluated is image processing suitable for character recognition. Thus, the evaluation accuracy of the character recognition result by a user increases. This assists the user in determining the OCR accuracy (i.e., evaluating the OCR result). The configuration of the system 9 according to the present embodiment is substantially the same as the configuration of the system 9 according to Embodiment 1 described above with reference to FIG. 1, and thus a redundant description thereof is omitted.

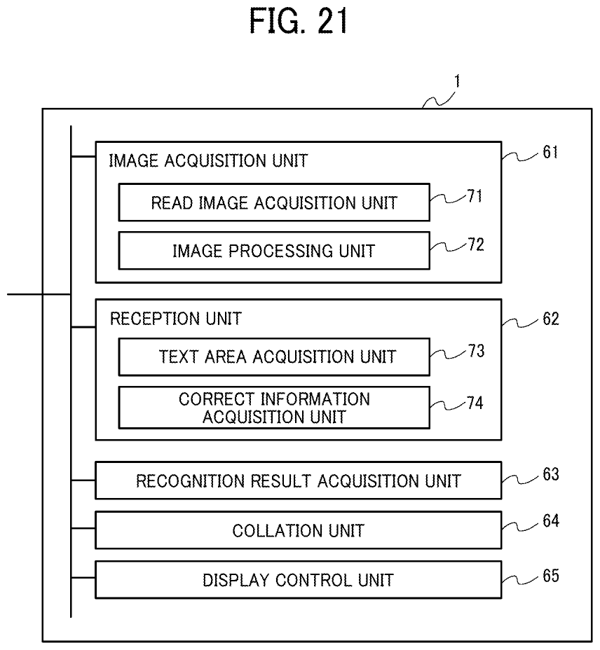

FIG. 21 is a schematic diagram illustrating a functional configuration of the information processing apparatus 1 according to the present embodiment. The CPU 11 executes a program loaded onto the RAM 13 from the storage device 14, to control the hardware components of the information processing apparatus 1. Thus, the information processing apparatus 1 functions as an apparatus including an image acquisition unit 61, a reception unit 62, a recognition result acquisition unit 63, a collation unit 64, and a display control unit 65. The image acquisition unit 61 includes a read image acquisition unit 71 and an image processing unit 72. The reception unit 62 includes a text area acquisition unit 73 and a correct information acquisition unit 74.

In the present embodiment and other embodiments described below, the functions of the information processing apparatus 1 are executed by the CPU 11 which is a general-purpose processor. Alternatively, a part or all of these functions may be executed by one or multiple dedicated processors.

The image acquisition unit 61 acquires a captured image obtained by imaging a document. The image acquisition unit 61 is substantially the same as the image acquisition unit 31 in Embodiment 1, and thus a redundant description thereof is omitted. However, in the present embodiment, the image processing unit 72 (corresponding to an “image processing means” according to the present embodiment) performs image processing (i.e., image processing to be evaluated, which is a target on which evaluation of whether image processing is suitable for character recognition is to be performed) on a read image acquired by the read image acquisition unit 71. Thus, the image acquisition unit 61 acquires an image (processed image) on which image processing has been performed as a captured image.

The reception unit 62 receives designation of an OCR area and input of a correct character string for the read document by receiving an operation by the user for selecting a field (a text area (OCR area) which is an area including a character) in the read document (captured image) and an operation by the user for inputting the correct character string written in the area. The reception unit 62 is substantially the same as the reception unit 32 in Embodiment 1, and thus a redundant description thereof is omitted.

The recognition result acquisition unit 63 acquires a character recognition result for the captured image (processed image).

Specifically, the recognition result acquisition unit 63 acquires the character recognition result (i.e., a recognized character string) for a text area (OCR area) in the captured image (processed image). The recognition result acquisition unit 63 may acquire the character recognition result by performing character recognition processing (OCR processing). Alternatively, the recognition result acquisition unit 63 may acquire the character recognition result from another apparatus (apparatus including an OCR engine) that performs the character recognition process.

The collation unit 64 collates the correct character string with the recognized character string. The collation unit 64 collates (compares) the correct character string with the recognized character string for the same OCR area, to determine whether the correct character string and the recognized character string completely match. When the correct character string and the recognized character string do not completely match, the collation unit 64 identifies a character (a character having difference) that does not match between both character strings.

The display control unit 65 controls a displaying means (corresponding to the output device 16 of FIG. 1) to display one or more windows indicating the result of the collation between the correct character string and the recognized character string (i.e., the evaluation result regarding the character recognition result). The one or more windows allows a user to evaluate whether the image processing to be evaluated is image processing suitable for character recognition. In the present embodiment, the display control unit 65 controls the output device 16 to display two windows (i.e., a first window and a second window). The first window indicates the collation results for all of the OCR areas designated by the user in the captured image. The second window (pop-up window) indicates the collation result for each of the OCR areas. In the present embodiment, when the display control unit 65 controls the output device 16 to display the window indicating the collation result, the display control unit 65 controls the display of at least one window to vary according to the collation result between the correct character string and the recognized character string. In the present embodiment, as a method of controlling the display of the window to vary according to the collation result, two methods (i.e., Method 1 and Method 2) are described. According to the Method 1, the displaying mode of a predetermined window component relating to the window (i.e., the first window and/or the second window) is controlled to vary according to the collation result. According to the Method 2, the display content of a predetermined window component relating to the window (i.e., the first window and/or the second window) is controlled to vary according to the collation result. In the present embodiment, the second window is displayed by hovering a mouse over the OCR area on the first window.

Alternatively, the second window may be displayed in response to any processing to the OCR area other than the mouseover. For example, the second window may be displayed in response to processing of selecting the OCR area on the first window, such as a click operation.

### Method 1: Displaying Mode of OCR Area Frame

In the present embodiment, as described below, a captured image (processed image) is displayed on the first window, and a frame (borders) indicating an OCR area (text area) designated by a user is displayed as being superimposed on the captured image. In the following description, such a frame (borders) indicating an OCR area may be referred to as an “OCR area frame.” The display control unit 65 controls the displaying mode of the OCR area frame that is displayed as being superimposed on the captured image to vary according to the collation result. Specifically, the display control unit 65 controls the display of at least one of the color of the line of the OCR area frame, the thickness of the line of the OCR area frame, the type of the line of the OCR area frame (e.g., dotted line, solid line), and the background color (overlay) in the OCR area frame to vary according to the collation result.

### Method 1: Displaying Mode of Frame of Pop-Up Window

In the present embodiment, as described below, in response to a user's operation of hovering a mouse over a certain OCR area (an area within the OCR area frame) on the first window, a window (i.e., the second window) indicating the collation result of the certain OCR area pops up (i.e., the pop-up window is displayed). The display control unit 65 controls the displaying mode of a window frame surrounding the second window (i.e., the frame of the pop-up window) to vary according to the collation result of the OCR area. Specifically, the display control unit 65 controls the display of at least one of the color of the line of the window frame, the thickness of the line of the window frame, the type of the line of the window frame (e.g., dotted line or solid line), and the background color (overlay) within the window frame to vary according to the collation result. The description above is of a case where, in the present embodiment, the displaying mode of the frame of the second window is controlled to vary. Alternatively, the displaying mode of the frame of the first window may be controlled to vary according to the collation result of all of the OCR areas designated by a user.

Method 1: Displaying Mode of Character that does not Match Between Character Strings

In the present embodiment, an icon, text indicating the collation result, a recognized character string (OCR text), and a correct character string (correct text) regarding an OCR area relating to the second window are displayed (arranged) on the second window (i.e., pop-up window). The display control unit 65 controls the displaying mode of a character in the recognized character string determined as not matching (being different from) a character in the correct character string to vary according to the collation result for the OCR area. In the following description, the character in the recognized character string determined as not matching (being different from) the character in the correct character string may be referred to as an “unmatched character.” Specifically, the display control unit 65 controls the display of at least one of the decoration (e.g., color, size, thickness, italics, and underline) of the unmatched character, the background color of the unmatched character, and the font of the unmatched character to vary according to the collation result of the OCR area. The description given above is of a case where, in the present embodiment, the displaying mode of the unmatched character displayed on the second window is controlled to vary. Alternatively, in a case where the recognized character string is displayed on the first window, the displaying mode of the unmatched character in the recognized character string displayed on the first window may be controlled to vary according to the collation result for the OCR area.

### Method 2: Type of Icon

As described above, in the present embodiment, an icon that indicates the collation result is displayed on the second window. The display control unit 65 controls the type of icon (e.g., circle, triangle, square) to vary according to the collation result for the OCR area. For example, when the correct character string and the recognized character string do not match in the OCR area, an icon (e.g., a mark other than a circle) that can more alert the user than when the correct character string and the recognized character string match is used. The description given above is of a case where, in the present embodiment, the displaying mode of the icon displayed on the second window is controlled to vary. Alternatively, in a case where the icon is displayed on the first window, the displaying mode of the icon displayed on the first window may be controlled to vary according to the collation result for the OCR area.

### Method 2: Content of Text Indicating Collation Result

As described above, in the present embodiment, text indicating the collation result (i.e., text for notifying a user of the collation result) is displayed on the second window. The display control unit 65 controls a content of the text (content of a sentence) to vary according to the collation result for the OCR area. For example, when the correct character string and the recognized character string do not match in the OCR area, the display control unit 65 controls the output device 16 to display text “Incorrect text is obtained” indicating the collation result. For example, when the correct character string and the recognized character string match in the OCR area, the display control unit 65 controls the output device 16 to display text “The correct text is obtained” indicating the collation result. The description given above is of a case where, in the present embodiment, the displaying mode of the text displayed on the second window is controlled to vary. Alternatively, in a case where the text is displayed on the first window, the displaying mode of the text displayed on the first window may be controlled to vary according to the collation result for the OCR area.

As described above, by controlling the display of the window indicating the collation result to vary according to the collation result between the correct character string and the recognized character string, a user is alerted of an OCR area in which the correct character string and the recognized character string do not match among multiple OCR areas. The description given above is of a case where the displaying mode and the display content of multiple window components vary according to the collation result. Alternatively, the displaying mode and the display content of at least any one of the multiple window components may vary according to the collation result. A description is now of various windows (user interfaces (UIs)) displayed on the displaying means by the display control unit 65.

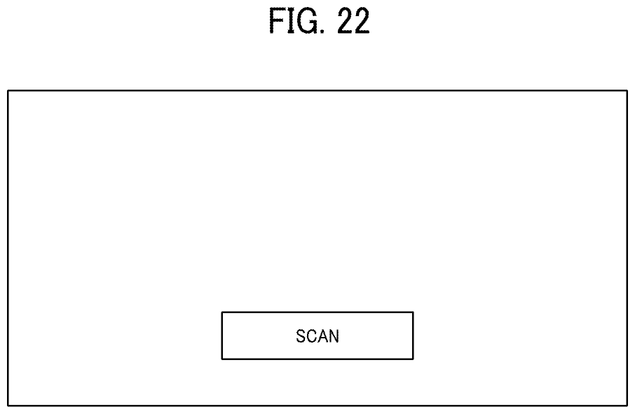

FIG. 22 is a diagram illustrating a document scan window, according to the present embodiment. As illustrated in FIG. 22, a button (i.e., a “SCAN” button) for scanning a document is displayed (arranged) on the scan window. In response to pressing the “SCAN” button by a user, a document is scanned and thus a captured image (document image) is generated. As a result, the image acquisition unit 61 acquires the captured image.

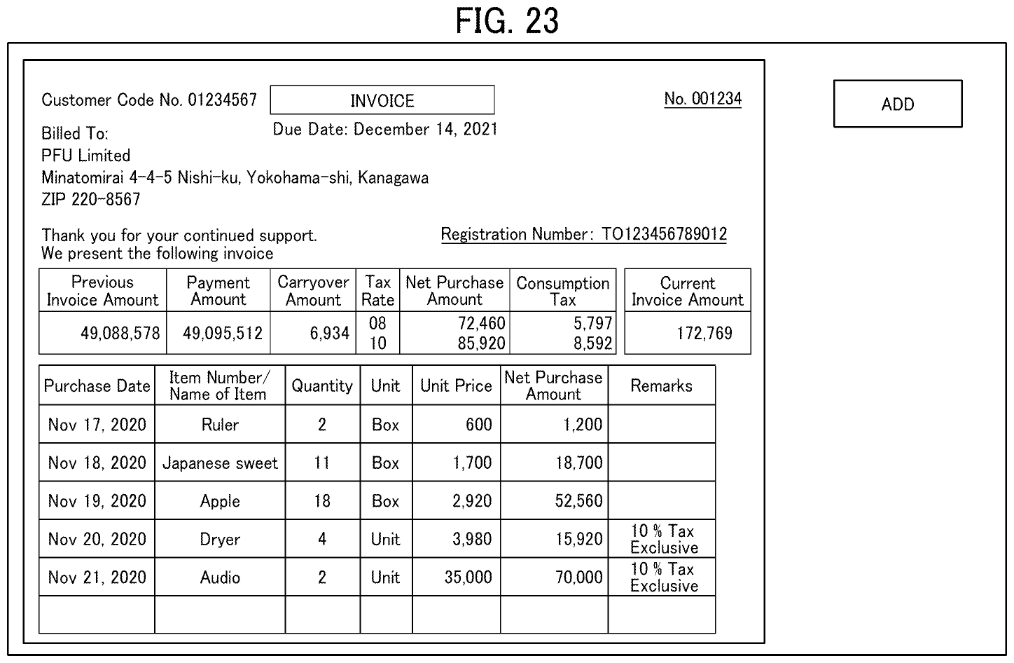

FIG. 23 is a diagram illustrating a pre-setting window before any setting is not yet configured, according to the present embodiment.

The window illustrated in FIG. 23 is a window for setting an OCR area and inputting a correct character string in advance. In other words, the window illustrated in FIG. 23 is an initial window. As illustrated in FIG. 23, a button (i.e., “ADD” button) for setting (adding) a captured image and an OCR area is displayed (arranged) on the pre-setting window before any setting is not yet configured. In response to pressing the “ADD” button by user, setting an OCR area and inputting a correct character string are enabled.

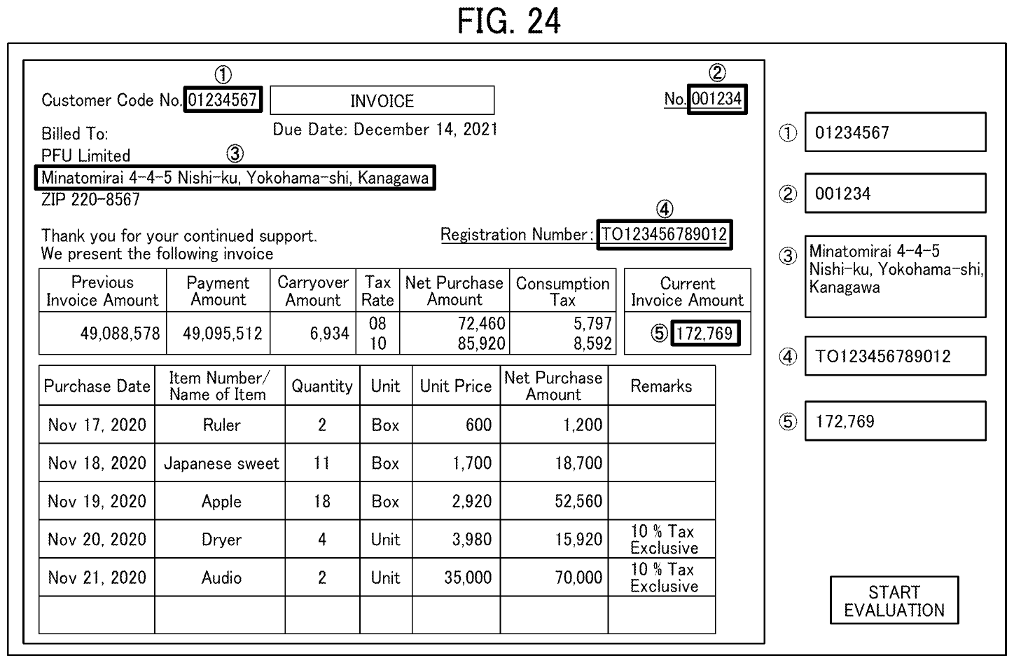

FIG. 24 is a diagram illustrating pre-setting window after the configuration of settings is completed, according to the present embodiment. The window illustrated in FIG. 24 is the pre-setting window after the setting of an OCR area and the input of the correct character string on the captured image are performed. FIG. 24 illustrates a case where five portions indicated by circled numbers 1 to 5 in the drawing are designated as OCR areas. As illustrated in FIG. 24, the captured image, OCR area designation frames, input forms for inputting correct character strings for the OCR areas, and a button (i.e., “START EVALUATION” button) for performing character recognition and evaluation of the character recognition result are displayed (arranged) on the pre-setting window after the configuration of settings is completed. Each of the input forms includes an input frame and a correct character string. As illustrated in FIG. 24, an OCR area is set (designated) on the captured image in response to a user's operation of pressing the “ADD” button in FIG. 23 and inputting a rectangular frame that surrounds an area for which the user wants OCR processing to be performed to designate the OCR area. As illustrated in the right area of the window of FIG. 24, the user can input character strings (i.e., correct character strings) that can be read from the OCR areas in input forms for correct character strings. In the example of FIG. 24, correct character strings “01234567,” “001234,” “Minatomirai 4-4-5 Nishi-ku, Yokohama-shi, Kanagawa,” “TO123456789012,” and “172,769” are input for the OCR areas at five positions indicted by the circled numbers 1 to 5 in the drawing. In response to pressing of the “START EVALUATION” button on this window, the window transitions to a display window of the evaluation result, and evaluation of the character recognition result is started.

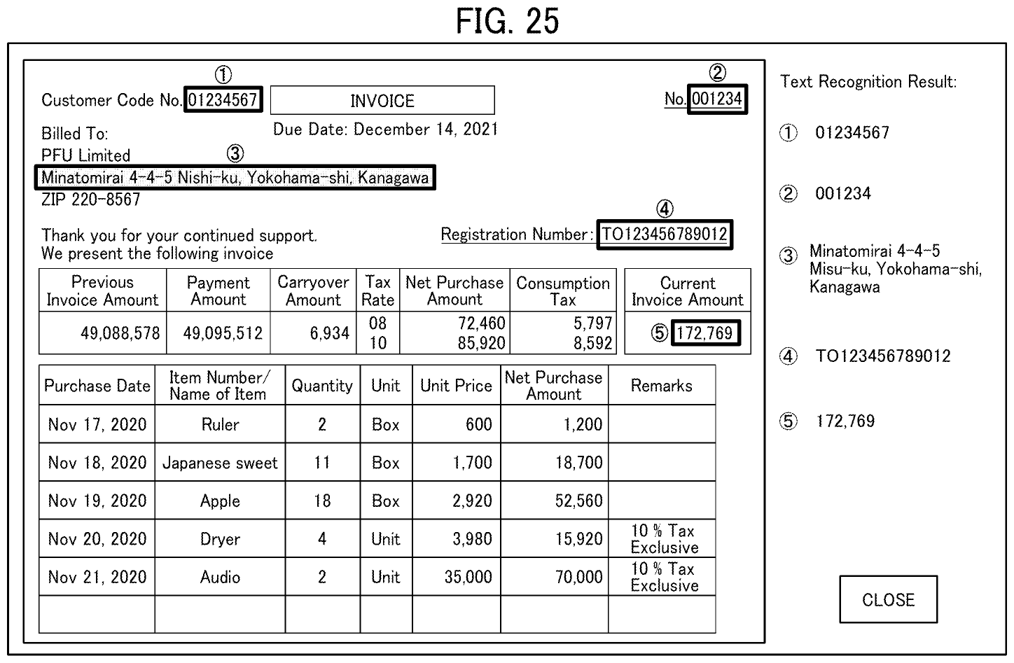

FIG. 25 is a diagram illustrating an evaluation result displaying window, according to the present embodiment. On the evaluation result displaying window (the first window described above), display is made according to the collation result between the correct character string and the recognized character string for each of the OCR areas. As illustrated in FIG. 25, on the evaluation result displaying window, the captured image, the OCR area frames for the OCR areas superimposed on the captured image, and the character recognition results are displayed (arranged). In the example of FIG. 25, text “01234567,” “001234,” “Minatomirai 4-4-5 Misu-ku, Yokohama-shi, Kanagawa,” “TO123456789012,” and “172,769” are extracted (i.e., the recognized character strings are obtained) for each of the five OCR areas indicted by the circled numbers 1 to 5 in the drawing. As a result of the collation between the correct character strings and the recognized character strings in the OCR areas, it is determined that the correct character string and the recognized character string do not match in the OCR area indicated by the circled number 3. Specifically, the characters “nishi” written in the OCR area indicated by the circled number 3 is erroneously read as “misu.” As a result, the display control unit 65 displays the OCR area frame of the OCR area indicated by the circled number 3 in a displaying mode corresponding to the determination result that the correct character string and the recognized character string do not match. On the other hand, for the OCR areas indicated by the circled numbers 1, 2, 4, and 5, the same texts (OCR text) as the correct character strings are acquired from the image. Accordingly, the display control unit 65 displays the OCR area frames of the OCR areas indicated by the circled numbers 1, 2, 4, and 5 in a displaying mode corresponding to the determination result that the correct character strings and the recognized character strings match.

For example, the display control unit 65 displays the OCR area frame of the OCR area indicated by the circled number 3 in red, with a thick line, and with a background color (overlay). Further, for example, the display control unit 65 displays the OCR area frames of the OCR areas indicated by the circled numbers 1, 2, 4, and 5 in green, with a thin line, and with no background color. In this way, the display control unit 65 may display the OCR area frame for a case where the correct character string and the recognized character string do not match in a mode that attracts more user's attention, compared to a displaying mode for a case where the correct character string and the recognized character string match.

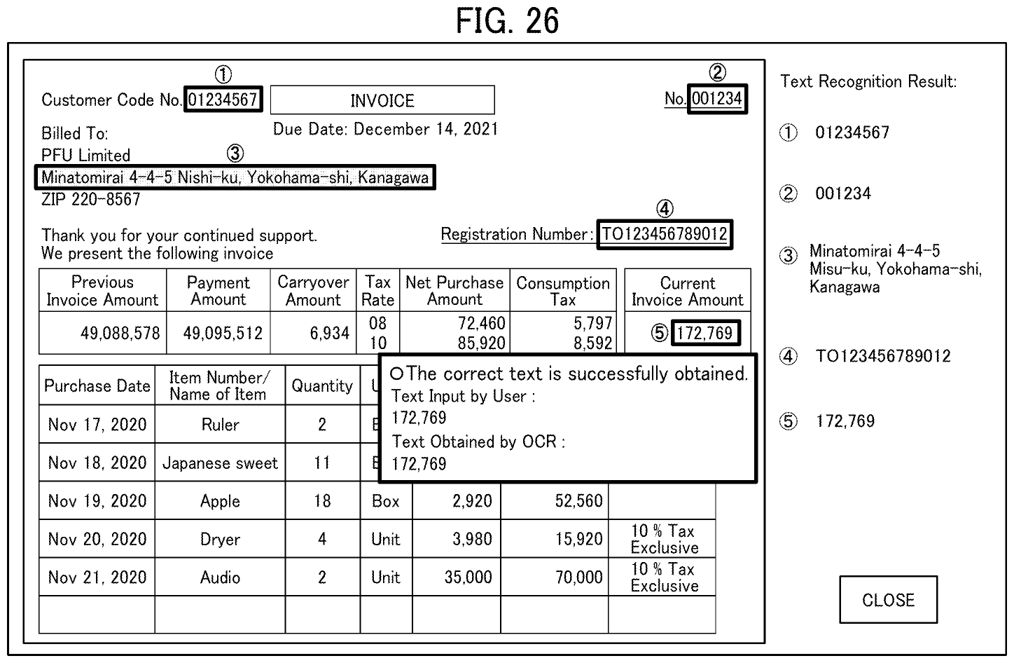

FIG. 26 is a diagram illustrating the evaluation result displaying window that is displayed when correct text is obtained, according to the present embodiment. In FIG. 26, in addition to the first window illustrated in FIG. 25, a window (pop-up window) displayed in response to an operation of hovering a mouse over the OCR area (text area) indicated by the circled number 5 in the window of FIG. 25 is displayed. The pop-up window is the above-described second window which indicates the collation result for the OCR area indicated by the circled number 5. As described above, for the OCR area indicated by the circled number 5, the same text (OCR text) as the correct character string is obtained from the image. In this case, the second window is displayed in a displaying manner corresponding to the match between the correct character string and the recognized character string.

For example, the window frame of the second window, text indicating the collation result displayed on the second window, and the type of an icon displayed on the second window are displayed in a displaying mode and a display content corresponding to the match between the correct character string and the recognized character string. For example, the window frame of the second window is displayed in green, with a thin line, and with a white background color. Further, text “The correct text is successfully obtained” indicating the collation result is displayed. Furthermore, a green circle icon is displayed.

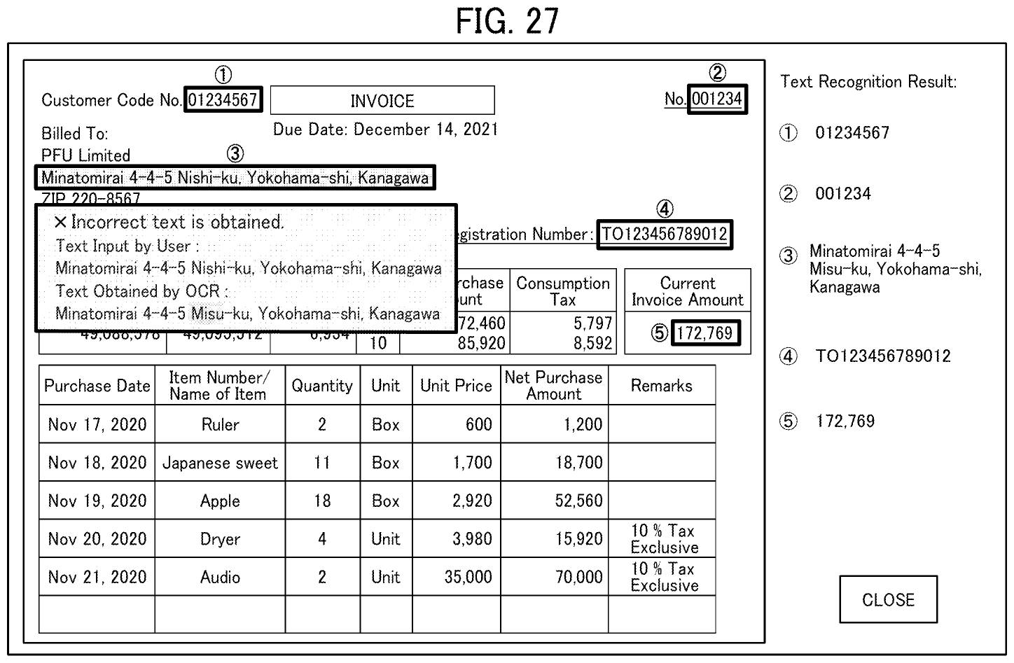

FIG. 27 is a diagram illustrating the evaluation result displaying window that is displayed when correct text is not obtained, according to the present embodiment. In FIG. 27, in addition to the first window illustrated in FIG. 25, a window (pop-up window) displayed in response to an operation of hovering a mouse over the OCR area (text area) indicated by the circled number 3 in the window of FIG. 25 is displayed. The pop-up window is the above-described second window which indicates the collation result for the OCR area indicated by the circled number 3. As described above, for the OCR area indicated by the circled number 3, the same text (OCR text) as the correct character string is not obtained from the image. In this case, the second window is displayed in a displaying manner corresponding to the determination result that the correct character string and the recognized character string do not match.

For example, the window frame of the second window, an unmatched character displayed on the second window, text indicating the collation result displayed on the second window, and the type of an icon displayed on the second window are displayed in a displaying mode and a display content corresponding to the determination result that the correct character string and the recognized character string do not match. For example, the window frame of the second window is displayed in red, in a thick line, and in a red background color. Further, the unmatched character is displayed in italics, bold, and red. The background color of the unmatched character is displayed in red, which is darker than the background color of the window. Furthermore, text “Incorrect text is obtained” indicating the collation result is displayed. Moreover, a red triangle icon is displayed.

As can be seen from the comparison between the pop-up windows of FIG. 26 and FIG. 27, the display control unit 65 controls the displaying mode and the display content of the pop-up window displayed in a case where the correct character string and the recognized character string do not match to be a mode and a content that attract more user's attention, compared to a displaying mode and a display content for a case where the correct character string and the recognized character string match.

The description given above with reference to FIG. 25 to FIG. 27 is of a case where the character recognition result (i.e., recognized character string) is displayed in the right area of the window (circled numbers 1 to 5). Alternatively, in this area, the correct character string and/or the recognized character string may be displayed. Still alternatively, in this area, the correct character string and the recognized character string may not be displayed.

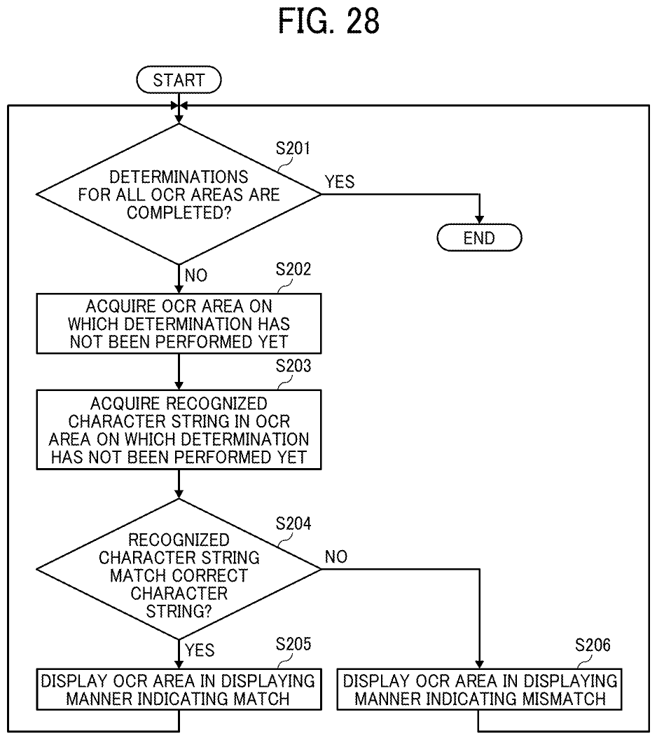

FIG. 28 is a flowchart of a process for displaying an evaluation result, according to the present embodiment. The process illustrated in the flowchart starts, for example, in response to the information processing apparatus 1 receiving, after obtaining a captured image (image data) by scanning a document for which a user wants OCR to be performed, an operation for designating an OCR area and an operation for inputting a correct character string. For example, the process started in response to pressing of the “START EVALUATION” button on the window illustrated in FIG. 24.

In step S201, whether determinations for all OCR areas are completed is determined. Specifically, the collation unit 64 determines whether determinations of the recognized character string and the correct character string match have been performed for all the OCR areas designated by a user. When the determinations of whether the recognized character string and the correct character string match have been performed for all the OCR areas (YES in step S201), the process illustrated in the flowchart ends. By contrast, when the determinations of whether the recognized character string and the correct character string match have not been performed for all the OCR areas (NO in step S201), the process proceeds to step S202.

In step S202, an OCR area for which the determination is not completed is acquired. The recognition result acquisition unit 63 acquires one OCR area (an image relating to the OCR area) from among OCR areas for which the determination result in step S201 indicates that the determinations of whether the recognized character string and the correct character string match have not been performed yet. The process then proceeds to step S203.

In step S203, a recognized character string for the OCR area for which the determination has not been performed yet is acquired. The recognition result acquisition unit 63 acquires a recognized character string for the OCR area acquired in step S202. The process then proceeds to step S204.

In step S204, whether the recognized character string matches the correct character string is determined. The collation unit 64 collates (compares) the recognized character string acquired in step S203 with the correct character string for the OCR area acquired in step S202, which is input by a user in advance, and determines whether these character strings match. When the recognized character string and the correct character string match (YES in step S204), the process proceeds to step S205. By contrast, when the recognized character string and the correct character string do not match (NO in step S204), the process proceeds to step S206.

In step S205, the OCR area (OCR area frame) is displayed in a displaying manner corresponding to the match between the correct character string and the recognized character string (in a displaying mode indicating the match between the correct character string and the recognized character string). The display control unit 65 displays the OCR area frame for the OCR area acquired in step S202 in a displaying manner (displaying mode) corresponding to the match between the recognized character string and the correct character string (see FIG. 25). The process then returns to step S201.

In step S206, the OCR area (OCR area frame) is displayed in a displaying manner corresponding to the determination result that the recognized character string and the correct character string do not match (in a displaying mode indicating that the recognized character string and the correct character string do not match). The display control unit 65 displays the OCR area frame of the OCR area acquired in step S202 in a displaying manner (displaying mode) corresponding to the determination result that the recognized character string and the correct character string do not match (see FIG. 25). The process then returns to step S201.

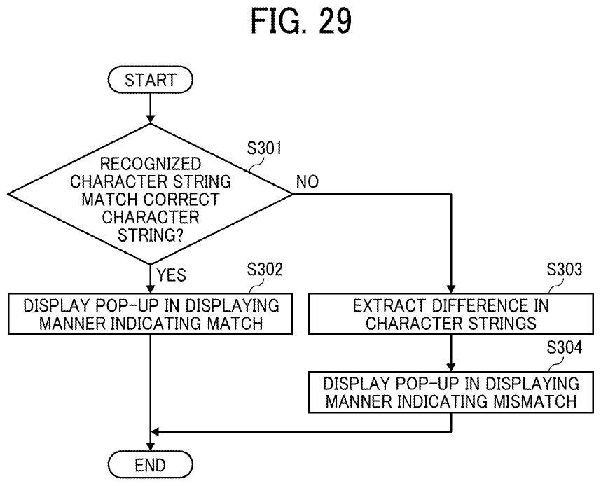

FIG. 29 is a flowchart of a pop-up display process, according to the present embodiment. The process illustrated in the flowchart starts, for example, in response to a user's operation of hovering a mouse over the OCR area. For example, the process starts in response to hovering a mouse over the OCR area on the window illustrated in FIG. 25.

In step S301, whether the recognized character string matches the correct character string is determined. The collation unit 64 determines whether the recognized character string and the correct character string match for the OCR area over which the mouse is hovered. When the recognized character string and the correct character string match (YES in step S301), the process proceeds to step S302. By contrast, when the recognized character string and the correct character string do not match (NO in step S301), the process proceeds to step S303.

In step S302, a pop-up window is displayed in a displaying manner corresponding to the match between the correct character string and the recognized character string (i.e., in a displaying mode and/or a display content indicating that the correct character string and the recognized character string match). The display control unit 65 displays the window components (i.e., the window frame of the pop-up window, an icon, text indicating the collation result, and an unmatched character) of the pop-up window indicating the result (i.e., the collation result) determined in step S301 in a displaying manner (displaying mode and/or display content) corresponding to the determination result that the recognized character string and the correct character string match (see FIG. 26). Then, the process illustrated in the flowchart ends.

In step S303, a difference in the character string is extracted. The collation unit 64 extracts a difference (unmatched character) between the recognized character string and the correct character string for which the determination in step S301 indicates that the two character strings do not match. The process then proceeds to step S304.

In step S304, a pop-up window is displayed in a displaying manner corresponding to the determination result that the correct character string and the recognized character string do not match (i.e., in a displaying mode and/or a display content indicating that the correct character string and the recognized character string do not match). The display control unit 65 displays the window components (i.e., the window frame of the pop-up window, an icon, text indicating the collation result, and an unmatched character) of the pop-up window indicating the result (i.e., the collation result) determined in step S301 in a displaying manner (displaying mode and/or display content) corresponding to the determination result that the recognized character string and the correct character string do not match (see FIG. 27). Then, the process illustrated in the flowchart ends.

A user who has checked the collation result (i.e., the windows of FIG. 25 to FIG. 27) may repeatedly perform an operation of changing image processing settings and checking the collation result until a satisfactory result (character recognition result) is obtained. Specifically, it is assumed that the user who has checked the collation result judges that the collation result is not satisfactory. In this case, image processing different from the image processing performed on the captured image used for the collation result is performed on the read image according to a user's operation. In other words, image processing based on an image processing setting different from the image processing setting by the image processing unit 72 is performed. Thus, a captured image (processed image) different from the captured image used for the collation result is obtained. Then, the above-described process is performed on the newly obtained captured image. Thus, the collation result for the newly obtained captured image is obtained, and the window (the window of FIG. 25 to FIG. 27) indicating the collation result is displayed by the above-described display control process. Then, the user checks the collation result again to check whether a satisfactory result is obtained. When a result satisfying the user is obtained by repeatedly performing the processes, the image processing setting according to which the satisfying result is obtained may be stored and used for the subsequent operation. For example, the information processing apparatus 1 according to the present embodiment includes a functional unit (e.g., an evaluation acquisition unit) that acquires, from a user, an evaluation result indicating that a character recognition result is satisfactory, that is, an evaluation result indicating that the performed image processing is image processing suitable for character recognition. The evaluation acquisition unit may acquire the evaluation result that the performed image processing is image processing suitable for character recognition in response to a user's operation of pressing, on a window indicating the collation result, for example, a button (e.g., an “OK” button), which is to be pressed when the character recognition result is a satisfactory result (i.e., when the performed image processing is image processing suitable for character recognition). Further, in response to pressing of the “OK” button by a user, the image processing setting according to which the satisfactory result is obtained may be stored in a memory. In the above-described process, the change of image processing (i.e., change of an image processing setting) may be performed manually according to a user's operation or may be performed automatically by a function on the program.

As described, the system 9 according to the present embodiment controls the display of a window (i.e., a window displaying a result of collation between a correct character string and a recognized character string) for checking a character recognition result of an image on which image processing to be evaluated is performed to vary according to the result of the collation. The window allows a user to evaluate whether the image processing to be evaluated is image processing suitable for character recognition. Thus, the evaluation accuracy of the character recognition result by a user increases. In other words, a user is prevented from making an erroneous determination when comparing a correct character string with a recognized character string. This assists a user in determining (evaluating) a character recognition result. According to the present embodiment, whether OCR text (recognized character string) is correct is determined by comparing the OCR text with correct text that is input in advance by a user, instead of by the confidence level of the recognized character string. Accordingly, whether OCR text (recognized character string) is correct (i.e., the OCR text matches the correct text) is determined with high accuracy (100% accuracy). Further, according to the present embodiment, the display of a window indicating a collation result is controlled to vary according to the collation result between the correct character string and the recognized character string. Thus, a user's attention is attracted to an OCR area in which the correct character string and the recognized character string do not match among multiple OCR areas.

### Embodiment 5

In the present embodiment, an embodiment combining Embodiment 1 and Embodiment 4 is described. In other words, a description is given of a system that evaluates whether a determined recommended setting is a setting suitable for character recognition (i.e., whether image processing based on the recommended setting (image processing by the recommended setting) is processing suitable for character recognition).

In the present embodiment, first, a recommended setting is determined by the method according to Embodiment 1. Subsequently, by the method according to Embodiment 4, a character recognition result for an image reflecting the determined recommended setting is acquired, and a window indicating an evaluation result of the acquired character recognition result (i.e., the collation result between a recognized character string and a correct character string) is displayed. The display of this window is controlled to vary according to the collation result between the recognized character string and the correct character string by the method according to Embodiment 4. The configuration of the system 9 according to the present embodiment is substantially the same as the configuration of the system 9 according to Embodiment 1 described above with reference to FIG. 1, and thus a redundant description thereof is omitted.

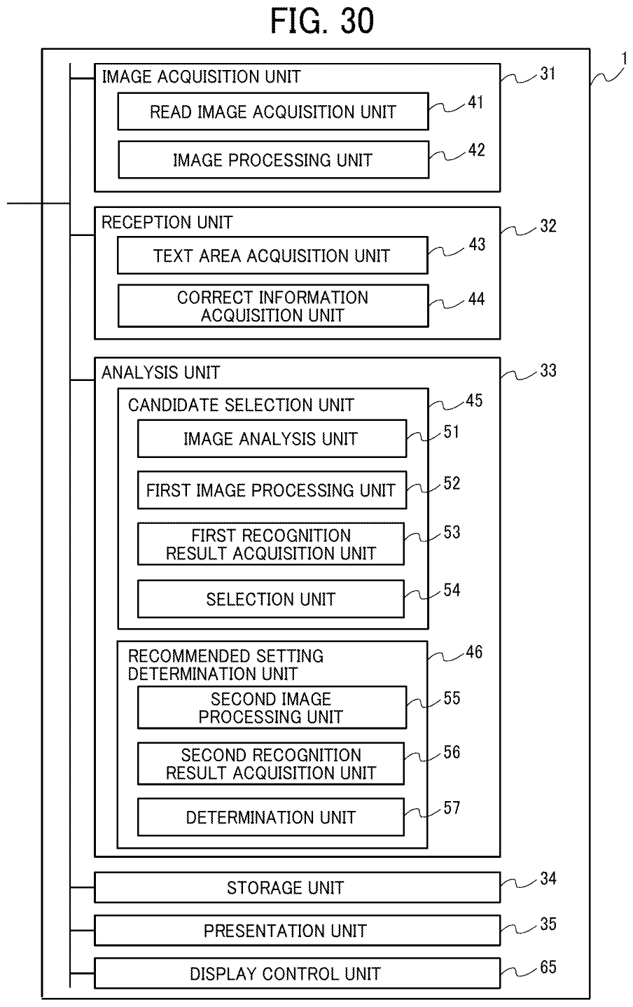

FIG. 30 is a schematic diagram illustrating a functional configuration of the information processing apparatus 1 according to the present embodiment. The CPU 11 executes a program loaded onto the RAM 13 from the storage device 14, to control the hardware components of the information processing apparatus 1. Thus, the information processing apparatus 1 functions as an apparatus including the image acquisition unit 31, the reception unit 32, the analysis unit 33, the storage unit 34, the presentation unit 35, and the display control unit 65. The image acquisition unit 31 includes the read image acquisition unit 41 and the read image processing unit 42. The reception unit 32 includes the text area acquisition unit 43 and the correct information acquisition unit 44. The analysis unit 33 includes the candidate selection unit 45 and the recommended setting determination unit 46. The candidate selection unit 45 includes the image analysis unit 51, the first image processing unit 52, the first recognition result acquisition unit 53, and the selection unit 54. The recommended setting determination unit 46 includes the second image processing unit 55, the second recognition result acquisition unit 56, and the determination unit 57. In the present embodiment and other embodiments described below, the functions of the information processing apparatus 1 are executed by the CPU 11 which is a general-purpose processor. Alternatively, a part or all of these functions may be executed by one or multiple dedicated processors.

The image acquisition unit 31, the reception unit 32, the analysis unit 33, the storage unit 34, and the presentation unit 35 in the present embodiment are substantially the same as the image acquisition unit 31, the reception unit 32, the analysis unit 33, the storage unit 34, and the presentation unit 35 in Embodiment 1, and thus redundant descriptions thereof are omitted. Further, the display control unit 65 in the present embodiment is substantially the same as the display control unit 65 in Embodiment 4, and thus a redundant description thereof is omitted. The second image processing unit 55 corresponds to the “image processing means” in Embodiment 4. The correct information acquisition unit 44 corresponds to a “correct information acquisition means” in Embodiment 4. The second recognition result acquisition unit 56 corresponds to a “recognition result acquisition means” in Embodiment 4. A “collation means” in Embodiment 4 corresponds to a means (functional unit) that the determination unit 57 in the present embodiment includes.

In the present embodiment, when the analysis unit 33 (the recommended setting determination unit 46) determines a recommended setting (image processing setting suitable for character recognition), the display control unit 65 controls the displaying means to display a window that allows a user to evaluate whether image processing based on the recommended setting is image processing suitable for character recognition. For example, the display control unit 65 controls the displaying means to display the evaluation result displaying window as illustrated in FIG. 25 in a displaying manner corresponding to the collation results between the correct character string and the recognized character string for the OCR areas. In the present embodiment, an image reflecting the recommended setting (i.e., an image on which image processing based on the recommended setting is performed), an OCR area frame, and a character recognition result are displayed on the evaluation result displaying window.

In the present embodiment, a character recognition result acquired in advance by the second recognition result acquisition unit 56 in the recommended setting determination process is displayed on the window. The displayed character recognition result is a character recognition result for an image on which the image processing based on the recommended setting (the image processing setting determined as the recommended setting later) is performed. Alternatively, a recommended setting may be first determined, and then the second image processing unit 55 may perform image processing based on the determined recommended setting on the captured image again, to obtain a processed image. In this case, the second recognition result acquisition unit 56 acquires a character recognition result for the obtained processed image, and then the acquired character recognition result may be displayed on the window.

In the present embodiment, it is assumed that the above-described Evaluation method 1 is used in the recommended setting determination process. In this case, in the recommended setting determination process, the collation between the correct character string and the recognized character string (i.e., determination of whether the two character strings match) for the OCR areas in the image reflecting the recommended setting (the image processing setting determined as the recommended setting later) has been already performed. Thus, the display control unit 65 can control the display of the evaluation result displaying window to be a display corresponding to the result of the collation process which has been already performed, without performing the collation process after the recommended setting is determined. In other words, when the recommended setting is determined by the process illustrated in the flowchart of FIG. 16, the processing of step 205 or step S206 in the flowchart of FIG. 28 is performed according to the result of the collation process that is already performed for the recommended setting.

In a case where the above-described Evaluation method 2 is used in the recommended setting determination process, in the recommended setting determination process, the collation between the correct character string and the recognized character string (i.e., determination of whether the two character strings match) for the OCR areas in the image reflecting the recommended setting (the image processing setting determined as the recommended setting later) is not performed. In this case, the collation unit 64 described in Embodiment 4 collates the correct character string with the recognized character string for the OCR areas in the image reflecting the recommended setting. Further, the display control unit 65 controls the display according to the result of the collation by the collation unit 64. In other words, after the recommended setting is determined by the process illustrated in the flowchart of FIG. 16, the process illustrated in the flowchart of FIG. 28 is performed. In this case, in step S203 of FIG. 28, the recognition result acquisition unit 63 may newly acquire, after the recommended setting is determined, a recognized character string for an image reflecting the determined recommended setting. Alternatively, the recognition result acquisition unit 63 may acquire a recognized character string for the recommended setting (image processing setting determined as the recommended setting later) which has been already acquired in the recommended setting determination process from, for example, the storage device 14.

A user who has checked the collation result (i.e., the windows of FIG. 25 to FIG. 27) may repeatedly perform an operation of changing image processing settings and checking the collation result until a satisfactory result (character recognition result) is obtained. Thus, an image processing setting more suitable for character recognition is determined. Specifically, it is assumed that the user who has checked the collation result regarding the recommended setting judges that the collation result is not satisfactory. In this case, the user corrects (changes) the recommended setting. Then, for example, the second image processing unit 55 performs image processing based on the corrected recommended setting on the read image. Thus, an image different from the image reflecting the recommended setting before the correction is obtained. Subsequently, for example, the second recognition result acquisition unit 56 acquires a character recognition result (recognized character string) for the newly obtained image. The determination unit 57 (the collation means) collates the recognized character string with the correct character string (i.e., acquires a collation result). The display control unit 65 displays a window (i.e., the window illustrated in FIG. 25 to FIG. 27) indicating the collation result. Then, the user checks the collation result again to check whether a satisfactory result is obtained. When a result satisfying the user is obtained by repeatedly performing the processes, the image processing setting according to which the satisfying result is obtained may be stored and used for the subsequent operation. As described above, the information processing apparatus 1 according to the present embodiment includes the evaluation acquisition unit. Accordingly, the evaluation acquisition unit may acquire the evaluation result that the performed image processing is image processing suitable for character recognition in response to a user's operation of pressing, on a window indicating the collation result, for example, a button (e.g., an “OK” button), which is to be pressed when the performed image processing is image processing suitable for character recognition. Further, in response to pressing of the “OK” button by a user, the storage unit 34 may store the image processing setting according to which the satisfactory result is obtained.

In the above-described process, the change of the recommended setting may be performed manually according to a user's operation or may be performed automatically by a function on the program. For example, as described in Embodiment 1, when the proposal of the image processing settings (presentation of the recommended settings) by the presentation unit 35 is not satisfactory, the analysis unit 33 performs the above-described analysis process again with, for example, the OCR area being changed, to again determine image processing settings (recommended settings) suitable for OCR. The recommended setting may be automatically changed by using the recommended settings thus determined again.

A display control method (a method of controlling the display of the window to vary according to the collation result) in the present embodiment is substantially the same as the method described in Embodiment 4, and thus a redundant description thereof is omitted. Further, the flow of the pop-up display process in the present embodiment is substantially the same as the flow of the pop-up display process in Embodiment 4 described above with reference to FIG. 29, and thus a redundant description thereof is omitted.

According to the present embodiment, the display of a window (i.e., a window displaying a result of collation between a correct character string and a recognized character string) that allows a user to evaluate whether image processing with a recommended setting is image processing suitable for character recognition is controlled to vary according to the result of the collation. This makes it easy for a user to evaluate whether image processing based on the recommended setting that is determined to obtain an image suitable for character recognition is image processing suitable for character recognition. Specifically, even after image processing suitable for character recognition is performed, text that cannot be read by OCR or misreading may occur. For this reason, a user sometimes actually checks character recognition accuracy of an image on which image processing suitable for character recognition has been performed to check whether misreading is present. In this case as well, according to the present embodiment, a user can determine whether “text read by the user” and “text read by OCR” match in a simple manner. This assists a user to check text. Further, an image processing setting for OCR is configured more efficiently. Further, according to the present embodiment, when a user determines whether to change the recommended setting (whether to perform a process of re-determining a recommended setting) on the basis of a character recognition result, misreading is prevented. Accordingly, the determination of whether to change the recommended setting is performed appropriately.

In the related art, when converting an original document (paper document) such as a document and a slip into data, character recognition processing (optical character recognition (OCR) processing) is performed on an image obtained by reading the original document by an image reading apparatus such as a scanner. However, character recognition accuracy sometimes deteriorates due to various factors such as a background pattern of an original document, noise, a ruled line, a character overlapped with a stamp imprint, and the blurring of a character. Various image processing settings (settings relating to the image reading apparatus) to eliminate these factors that degrade the character recognition accuracy (i.e., enhance the character recognition accuracy) are present. However, it is difficult for a user to configure these settings for obtaining an image suitable for character recognition by appropriately combining these settings.

According to one or more embodiments of the present disclosure, an image processing setting that can obtain an image suitable for character recognition is identified in a simple manner.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing system, comprising circuitry configured to:
acquire a captured image by capturing a document;
perform an analysis process using the captured image;
based on a result of the analysis process, select, for each of at least one setting item of a plurality of setting items relating to image processing to be performed on the captured image, at least one setting value from among configurable setting values as a candidate for a recommended setting;
perform image processing repeatedly on the captured image while changing setting values of the plurality of setting items with a setting value of the at least one setting item restricted to the at least one setting value selected as the candidate for the recommended setting; and
based on a result of the image processing, determine recommended settings for the plurality of setting items relating to image processing to obtain an image suitable for character recognition.

2. The information processing system of claim 1, wherein
the circuitry selects the candidate for the recommended setting by performing image analysis on the captured image as the analysis process.

3. The information processing system of claim 2, wherein
the at least one setting item includes a setting item relating to background pattern removal, and
the circuitry determines a background pattern amount on the captured image by performing an image analysis for determining the background pattern amount on the captured image, and according to result of the image analysis, selects at least one setting value of the setting item relating to the background pattern removal as the candidate for the recommended setting for the setting item relating to the background pattern removal.

4. The information processing system of claim 3, wherein
the circuitry performs edge analysis on the captured image to determine the background pattern amount.

5. The information processing system of claim 2, wherein
the at least one setting item includes a setting item relating to a dropout color, and
the circuitry performs an image analysis for determining presence of a ruled line, and according to a result of the image analysis, selects at least one setting value of the setting item relating to a dropout color as the candidate for the recommended setting for the setting item relating to the dropout color.

6. The information processing system of claim 5, wherein
in a case that a result of the image analysis for determining presence of a ruled line indicates that the ruled line is present, the circuitry identifies a color of the ruled line, and according to the identified color, selects the setting value of the setting item relating to the dropout color as the candidate for the recommended setting for the setting item relating to the dropout color.

7. The information processing system of claim 2, wherein
the at least one setting item includes at least one of a setting item relating to a binarization sensitivity or a setting item relating to a noise removal, and
the circuitry determines a noise amount using the captured image by performing an image analysis for determining the noise amount on the captured image, and according to a result of the image analysis, selects at least one setting value of the at least one of the setting item relating to the binarization sensitivity or the setting item relating to the noise removal as the candidate for the recommended setting for the at least one of the setting item relating to the binarization sensitivity or the setting item relating to the noise removal.

8. The information processing system of claim 7, wherein
in the image analysis for determining the noise amount, the circuitry calculates a number of black connected pixel blocks in a text area in a binarized image of the captured image, and according to comparison result between the number of black connected pixel blocks and an expected number of black connected pixel blocks for the text area obtained based on a correct character string for the text area, selects at least one setting value of the setting item relating to the at least one of the setting item relating to the binarization sensitivity or the setting item relating to the noise removal as the candidate for the recommended setting for the at least one of the setting item relating to the binarization sensitivity or the setting item relating to the noise removal.

9. The information processing system of claim 8, wherein
the circuitry calculates the expected number of black connected pixel blocks based on a language of text in the text area and a number of characters of the correct character string for the text area.

10. The information processing system of claim 1, wherein
the circuitry performs image processing on the captured image using the configurable setting values, and based on a character recognition result for an image obtained by performing the image processing, selects the setting value being the candidate for the recommended setting.

11. The information processing system of claim 10, wherein
the circuitry selects, as the candidates for the recommended settings, a predetermined number of setting values selected in descending order of the character recognition result from among the configurable setting values.

12. The information processing system of claim 1, wherein
the circuitry determines the recommended settings for the plurality of setting items based on character recognition results for a plurality of images obtained by repeatedly performing the image processing on the captured image while changing each of the setting values for the plurality of setting items.

13. The information processing system of claim 12, wherein
the circuitry determines, as the recommended settings for the plurality of setting items, a combination of the setting values relating to the plurality of setting items with which an image with a best character recognition result is obtained.

14. The information processing system of claim 1, further comprising a memory that stores the determined recommended settings for the plurality of setting items in association with identification information of the document.

15. The information processing system of claim 1, wherein
the plurality of setting items includes an image processing setting item relating to at least one of background pattern removal, specific character extraction, a dropout color, a binarization sensitivity, or noise removal.

16. The information processing system of claim 1, wherein
the circuitry is further configured to present the recommended settings for the plurality of setting items to a user.

17. The information processing system of claim 1, wherein
the circuitry is further configured to:
display one or more screens reflecting a result of collation between a recognized character string obtained by performing character recognition on a text area in an image reflecting the recommended settings and a correct character string corresponding to the text area on a display for allowing a user to evaluate whether the image processing according to the determined recommended settings is image processing suitable for character recognition; and
control a displaying manner of at least one screen of the one or more screens to vary according to the result of the collation.

18. The information processing system of claim 1, wherein the document is a plurality of documents.

19. A method comprising:
acquiring a captured image by capturing a document;
performing an analysis process using the captured image;
based on a result of the analysis process, selecting, for each of at least one setting item of a plurality of setting items relating to image processing to be performed on the captured image, at least one setting value from among configurable setting values, as a candidate for a recommended setting;
performing image processing repeatedly on the captured image while changing setting values of the plurality of setting items with a setting value of the at least one setting item restricted to the at least one setting value selected as the candidate for the recommended setting; and
based on a result of the image processing, determining recommended settings for the plurality of setting items relating to image processing to obtain an image suitable for character recognition.

20. A non-transitory computer-executable medium storing a plurality of instructions which, when executed by a processor, causes the processor to perform a method comprising:
acquiring a captured image by capturing a document;
performing an analysis process using the captured image;
based on a result of the analysis process, selecting, for each of at least one setting item of a plurality of setting items relating to image processing to be performed on the captured image, at least one setting value from among configurable setting values, as a candidate for a recommended setting;
performing image processing repeatedly on the captured image while changing setting values of the plurality of setting items with a setting value of the at least one setting item restricted to the at least one setting value selected as the candidate for the recommended setting; and
based on a result of the image processing, determining recommended settings for the plurality of setting items relating to image processing to obtain an image suitable for character recognition.
